(19) United States
(12) Patent Application Publication
(10) Pub. No.: US 2017/0081912 A1
(43) Pub. Date: Mar. 23, 2017

(54) SYSTEMS AND METHODS FOR MULTIPLE OPERATIONAL BLIND PARTITIONS

(71) Applicant: Andrew Guillory, San Francisco, CA (US)

(72) Inventor: Andrew Guillory, San Francisco, CA (US)

(21) Appl. No.: 15/265,498

(22) Filed: Sep. 14, 2016

Related U.S. Application Data
(60) Provisional application No. 62/390,966, filed on Apr. 14, 2016.
(60) Provisional application No. 62/388,353, filed on Jan. 25, 2016.
(60) Provisional application No. 62/387,801, filed on Jan. 4, 2016.
(60) Provisional application No. 62/386,718, filed on Dec. 9, 2015.
(60) Provisional application No. 62/386,275, filed on Nov. 24, 2015.
(60) Provisional application No. 62/284,117, filed on Sep. 18, 2015.

(51) Int. Cl. E06B 9/26; E06B 9/323; E06B 9/36; E06B 9/307; E06B 9/304; E06B 9/322; E06B 9/327

(52) U.S. Cl. CPC E06B 9/26; E06B 9/322; E06B 9/323; E06B 9/327; E06B 9/307; E06B 9/304; E06B 9/368; E06B 9/364; E06B 9/36; E06B 2009/2441

(57) ABSTRACT

A multi-partition blind system include a system of mechanisms that cause slats on a covering for an architectural opening to be partitioned into multiple operational sections. Partitions may be created to the extent of controlling each individual slat. Various embodiments and mechanisms are used to control, stabilize, and cause the opening and closing movement of one group of partitioned slats independent of others or individual slats independent of others.

### CROSS-REFERENCE TO RELATED APPLICATIONS

This non-provisional patent application claims the benefit of U.S. Provisional Application No. 62/390,966, filed Apr. 14, 2016; U.S. Provisional Application No. 62/388,353, filed Jan. 25, 2016; U.S. Provisional Application No. 62/387,801, filed Jan. 4, 2016; U.S. Provisional Application No. 62/386,718, filed Dec. 9, 2015; U.S. Provisional Application No. 62/386,275, filed Nov. 24, 2015; and U.S. Provisional Application No. 62/284,117, filed Sep. 18, 2015, which are hereby incorporated by reference herein in their entirety, including all references cited therein.

### FIELD OF THE INVENTION

The field of the present disclosure relates to coverings for architectural openings, and more particularly to multi-partition blind systems.

### BACKGROUND OF THE INVENTION

Window coverings for architectural openings typically comprise a head rail supported by brackets. The head rail supports and discretely contains operational mechanisms such as spools, pulleys, gears, brakes, shafts, spring motors, tensioning coils, tilting cords, lift cords, various housings that facilitate operational functionality, and the like. These operational mechanisms work in a coordinated manner to effect movement on a ladder system. The ladder system holds slats. Strings, tapes, cords, wands, and the like, are attached to and work in conjunction with the operational mechanisms so that when adequate force is applied the ladder system moves. The movement impact may be up, down, or tilting. The up and down movement may be in a top down, bottom up orientation, or both, for example. The movement in the ladder system is typically referred to as opening and closing.

The inner working mechanisms can be operated by exerting some form of external force applied to material such as string, cord, or a wand which are attached to the inner workings in such a manner that said force causes an up and down movement and/or opening and closing movement a ladder system when slats are in a horizontal orientation. Usually, there are separate materials such as the strings, cords, or wands that serve independent functions. For example, there may be a dedicated wand used to open and close the slats in the ladder system and cords used to raise or lower the entire ladder system. It is known in the art that these two functions may be combined, but more often in the marketplace we find the separate and independent functions as described here. The slats in some blinds are in a vertical orientation and there is no ladder system. In such cases, when an external force is applied to material such as string, cord, or wand that is attached to the inner working mechanisms enclosed in the head rail, the slats can be moved varying degrees rotatingly to an open or closed position. To gather or retract the vertical blinds fully, the user applies force to a wand or cords, for example, to draw the slats into a fully gathered position, a fully retracted position, or someplace in between.

The slats may be positioned in the ladder system or in a vertically oriented slat system so that they overlap, thereby blocking out the maximum amount of light when the slats are in the closed position. For blinds in a horizontal orientation, there is typically a bottom rail which serves to stabilize the ladder system of slats and provide a point where an impact of force is gathered that will allow the entire ladder system to move up or down. In the case of a cordless operation, a force may be applied to the bottom rail to cause the slat's tilting or rotational movement. Some operational methods allow for a lesser force requirement due to ratio advantages to cause the ladder system of slats to move in an up and down direction. Some operational methods employ a wand or spooled cords, for example, such that when adequate force is applied, the slats will move rotationally to an open or closed position. Other operational methods may employ an electrical power source, either alternating or direct current, to cause up, down, opening, or closing movement of ladder system and slats. Such electrical power may be coordinated and employed through a remote control device. The same sources of power may be used for slats that are vertically oriented.

Over a long period of time the field of blinds with slats has included characteristics such as a locking cord or string which allowed up and down movement and placement at a specific point without having to tie a string or cord to a cleat. Some blinds allow the operator to lift and lower with a reduced requirement of total force by applying a ratio to the inner workings that cause a transfer of weight from the slats through the use of gears, pulleys, and the like. It is understood in the art that the size of many mechanisms used to move and control a ladder system or vertically oriented blinds with slats have a proportional relationship to the size of the slats. For example, the mechanisms that would be employed in many instances to move two inch slats in a ladder system rotatingly to open or close positions would be larger than the mechanisms used to do the same with one inch slats. In the case of what is referred to as cordless blinds, the relationship between the slats and the mechanisms to move them up, down, or to tilt one direction or another can be predicated on counterbalancing. The resistance present on the controlling mechanism side must be in constant balance with the weight of the slats on the slat side so that the slats will remain in a desired position and also tilt directionally.

Many of the mechanisms described in the art have increased the functionality of blinds. The simpler the operating mechanisms, the more durable the functionality and the fewer the number of breakdowns that occurred over time. There is at least one significant problem that exists with both vertical and horizontal blinds with slats previously known in the art. Blinds with slats may be operated by employing wands, cords, or power, for example, to move slats rotatingly to an open or closed position. When adequate force is applied to such a wand or a cord, or through some other power source, all slats move in the same direction. When the blinds are in an extended position, the user may choose to use the wand or cord in our example to move the slats rotatingly to an open or closed position. Any number of available degrees of being opened or closed may be chosen, but all of the slats that can move will move essentially in the same direction and to the same extent under normal operating conditions. The user may choose to lift the blinds clear of a portion of the lower part of the architectural opening thereby allowing maximum light, but leave the blinds at a position less than completely gathered upward at the head rail. At such intermediate positions, the slats may be typically operated to move rotatingly to open or closed positions, but the user will have maximum exposure to light that comes through the lower portion of the window. Likewise, in this scenario, the user will lose some degree of privacy since the blinds are lifted halfway up and that part of the architectural opening is completely open.

In the case of cordless blinds in which there is both top down and bottom up orientation, a portion of either the upper or lower part of the architectural opening may be left clear of the blinds and there will be no further control over the amount of light that comes through the architectural opening. All of the slats, when moved, will go in the same direction and all slats that can move will have a common source of control that makes all slats behave in the same way. Unfortunately, these deficiencies have never been addressed previously.

### SUMMARY

This summary is provided to introduce a selection of concepts in a simplified form that is further described in the Detailed Description below. This summary is not intended to identify key features or essential features of the claimed subject matter, nor is it intended to be used as an aid in determining the scope of the claimed subject matter.

To solve the control problem of all slats moving rotatingly at the same time, the user desires to be able to have partitioned blinds one group of partitioned slats may be opened or closed independently of another group of partitioned slats. Each partition may have lifting and lowering functionality. The desire from the user can be described clearly in an example where the blinds are in a fully extended position. There is a significant gain in functionality when the user can leave the blinds in the fully extended state and choose to rotatingly open or close only the top portion of the slats or instead only the bottom portion of the slats. Having such a system of partitioned slats allows the user to control the inflow of light without fully raising or lowering the entire ladder system. In this example, the user has an opportunity to gain a degree of privacy by moving the lower partition of slats to a closed position and the upper partition to an open position. Additionally, the user has the option to control any number of partitioned slats in the manner of raising, lowering, opening or closing. A similar desire exists with blinds that have a vertical orientation. As an example, it happens that in some type architectural openings such as a patio door, the sunlight coming through may be desirable on one side but not the other. The purpose is to allow a desirable degree of light on one side without necessarily drawing the slats fully clear of the opposite side of the full patio door opening. In this case, the user's desire is to have separate controllable partitions that allow the slats in a respective partition to be moved rotatingly to an open or closed position.

The desire is to have an integrated system of either horizontally or vertically oriented blinds with two or more partitions or sections of slats that enable the user to operate and control the slats in any respective partition independently. In the present disclosure, for example, there may be two ladder systems employed to create upper and lower partitions. The slats in each partition will open or close independent of the other through the application of force to a wand, string, or cords. When the user desires more privacy while the blinds are fully extended, the lower slats, for example, may be closed and the upper partition opened. In this way, increased control over the amount of light entering an architectural opening is achieved in conjunction with significantly controlling the degree of privacy desired. Another embodiment of the present disclosure creates separate partitions with a mechanism that may be called by various names but will at this time be referred to as a midrail. The midrail may be used to create partitions in pre-existing blinds or blinds constructed or manufactured with multiple partitions. The midrail creates stability and allows numerous options for various approaches to installing multiple partitions that can be individually lifted or lowered and operate slats and causing the slats to move in a rotating manner to an open or closed position or some intermediary position.

Some blinds have slats that are positioned in a vertical orientation. The present disclosure may have a system of independently operating unique guide rails that form multiple partitions. Each unique partition allows for the independent opening and closing of the vertically oriented slats.

The partitions may have protective outer coverings, such as glass in a door or thin see-through cloth in other circumstances. Any of the embodiments of the present disclosure may be operated with the use of a power source such as electricity or direct current current, a timing mechanism, a remote control device, the like, or a functional combination of these.

In various embodiments, a multi-partition blind system comprises: (a) a first partition of blinds comprising: (i) a first set of slats; (ii) a first ladder system coupled to the first set of slats; and (iii) a first slat control fixture coupled to the first ladder system to facilitate rotating the first set of slats; and (b) a second partition of blinds comprising: (i) a second set of slats; (ii) a second ladder system coupled to the second set of slats; and (iii) second slat control fixture coupled to the second ladder system to facilitate rotating the second set of slats, the second set of slats rotating independently of the first set of slats.

In some embodiments, a multi-partition blind system comprises: (a) a top partition rail coupled to a first and a second side partition rail; and (b) a plurality of slats, each slat of the plurality of slats having a slat control fixture to facilitate independent rotation of each respective slat.

In one or more embodiments, a multi-partition blind system comprises: (a) a top partition rail; (b) a first partition of vertical blinds comprising: (i) a first guide shaft; (ii) a plurality of first fixtures coupled to the first guide shaft, each first fixture corresponding to a respective vertical blind of the first partition of vertical blinds; and (iii) a first driver fixture coupled to the first guide shaft; and (c) a second partition of vertical blinds comprising: (i) a second guide shaft; (ii) a plurality of second fixtures coupled to the second guide shaft, each second fixture corresponding to a respective vertical blind of the second partition of vertical blinds; and (iii) a second driver fixture coupled to the second guide shaft.

### BRIEF DESCRIPTION OF DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a front view of an exemplary multi-partition blind system having a first partition in a partially closed position and a second partition in an open position, according to the present disclosure.

FIG. 2 is a side view of the exemplary multi-partition blind system having the first partition in the partially closed position and the second partition in the open position, according to the present disclosure.

FIG. 3 is a front view of an exemplary multi-partition blind system having the first partition in an open position and the second partition in a partially closed position, according to the present disclosure.

FIG. 4 is a side view of the exemplary multi-partition blind system having the first partition in the open position and the second partition in the partially closed position, according to the present disclosure.

FIG. 5 is a top view of the exemplary multi-partition blind system having a top partition rail, in which the first partition in the closed position and the second partition in the open position, according to the present disclosure.

FIG. 6 is a cutaway front view of the top partition rail of FIG. 5, according to the present disclosure.

FIG. 7 is a cross section view of the top partition rail about line A-A in FIG. 6, according to the present disclosure.

FIG. 8 is a cross section view of the top partition rail about line B-B in FIG. 6, according to the present disclosure.

FIG. 9 is a top view of the top partition rail in which the first partition in the open position and the second partition in the closed position, according to the present disclosure.

FIG. 10 is a cutaway front view of the top partition rail of FIG. 9, according to the present disclosure.

FIG. 11 is a cross section view of the top partition rail about line C-C in FIG. 10, according to the present disclosure.

FIG. 12 is a cross section view of the top partition rail about line D-D in FIG. 10, according to the present disclosure.

FIG. 13 is a front view of another exemplary multi-partition blind system having a midrail, according to the present disclosure.

FIG. 14 is a side view of the exemplary multi-partition blind system, according to the present disclosure.

FIG. 15 is a top view of the midrail having a midrail partition in an open position, according to the present disclosure.

FIG. 16 is a perspective front view of the midrail, according to the present disclosure.

FIG. 17A is a front view of a further exemplary multi-partition blind system having an exemplary cordless lifting mechanism, according to the present disclosure.

FIG. 17B is a partial view of a top partition rail of the multi-partition blind system of FIG. 17A having the exemplary cordless lifting mechanism, according to the present disclosure.

FIG. 17C is a side view of an exemplary spool fixture in the top partition rail of FIG. 17A, according to the present disclosure.

FIG. 17D is a side view of an exemplary double pulley in the top partition rail of FIG. 17A, according to the present disclosure.

FIG. 18A is a front view of another further exemplary multi-partition blind system with automatic individual slat control, according to the present disclosure.

FIG. 18B is a left side view of a first side rail of FIG. 18A illustrating a plurality of slat control fixtures, according to the present disclosure.

FIG. 18C is a front view of a slat control fixture of FIG. 18B, according to the present disclosure.

FIG. 18D is a top view of a top partition rail of FIG. 18A, according to the present disclosure.

FIG. 19A is a front view of an additional exemplary multi-partition blind system with manual individual slat control, according to the present disclosure.

FIG. 19B is a top view of a slat control fixture for an individual slat of the multi-partition blind system of FIG. 19 in an engaged position, according to the present disclosure.

FIG. 19C is another top view of the slat control fixture in a disengaged position, according to the present disclosure.

FIG. 20A is a front view of another additional exemplary multi-partition blind system having vertical slats, according to the present disclosure.

FIG. 20B is a cutaway side view of a first fixture, according to the present disclosure.

FIG. 20C is a top view of two coupled first fixtures, according to the present disclosure.

FIG. 20D is a cutaway side view of a second fixture, according to the present disclosure.

FIG. 20E is a side view of a driver fixture, according to the present disclosure.

FIG. 20F is a diagrammatic representation of a side view of the top partition rail of FIG. 20A, according to the present disclosure

FIG. 20G is a top view of a partition appendage connector, according to the present disclosure.

FIG. 20H is a side view of the partition appendage connector of FIG. 20G, according to the present disclosure.

### DETAILED DESCRIPTION

The present disclosure is comprised of two or more partitions of ladder systems with slats where each respective ladder system's partition of slats may be operated to be fully opened, fully closed, or are to some degree opened or closed independently in each respective partition. In the embodiments of the present disclosure, the partitions may be lifted and lowered independently of one another and/or lifted in a manner where all partitions are gathered toward the top partition rail.

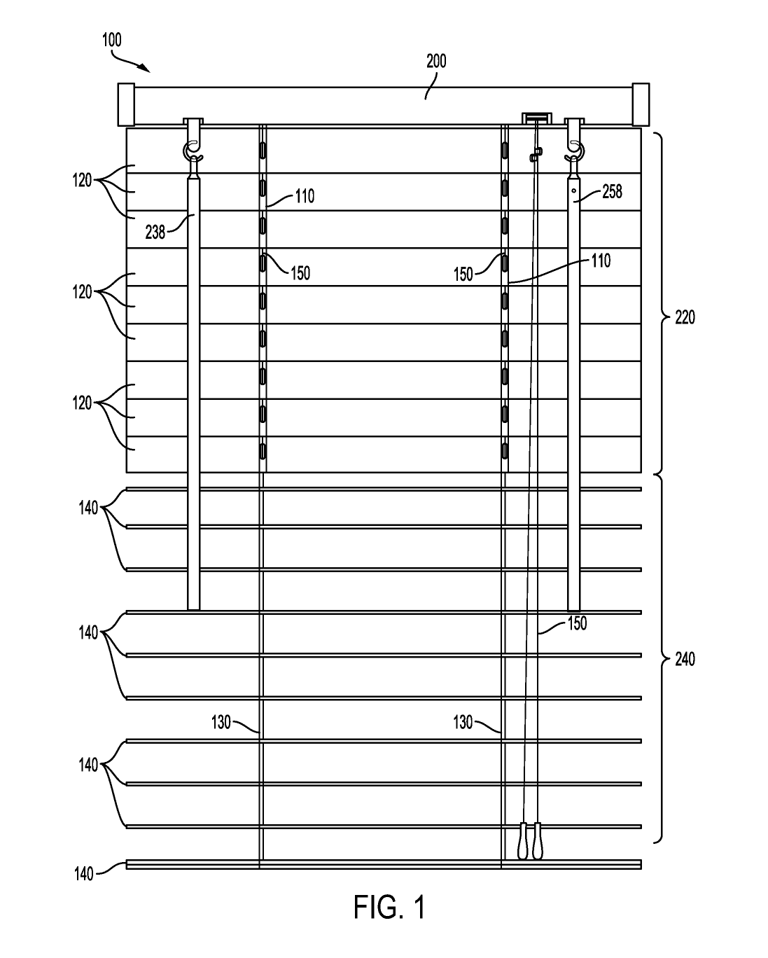

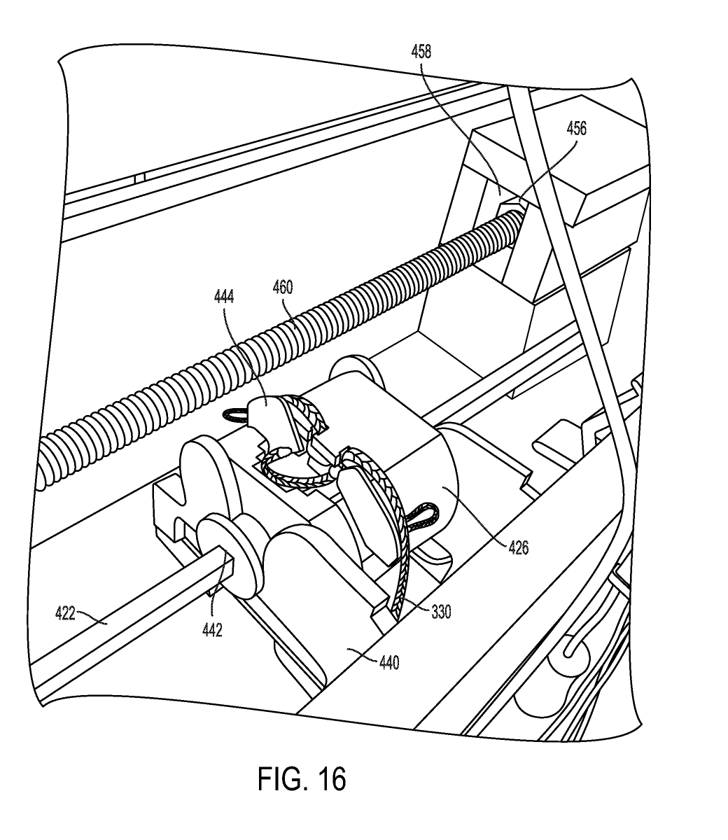

FIGS. 1-12 illustrate an exemplary system for a multi-partition blind system 100 having a top partition rail 200, a first partition 220 and a second partition 240. It is to be understood that the multi-partition blind system 100 may comprise any number of partitions, as will be described in the present disclosure.

FIGS. 1-4 depict each partition 220, 240 having an independent ladder system 110, 130 that supports a set of slats 120, 140. In some embodiments, the ladder systems 110, 130 are made from durable materials such as nylon string, cords, tape, or other suitable material for supporting the sets of slats 120, 140. For example, each ladder system 110, 130 may include a plurality of rungs coupled to a front support cord 112 and a back support cord 114, each rung of the plurality of rungs supporting a single slat. When the front support cord 112 is vertically displaced with respect to the back support cord 114, the plurality of rungs will be lifted or lowered at an angle, thus rotating the supported slats and opening or closing the respective partition.

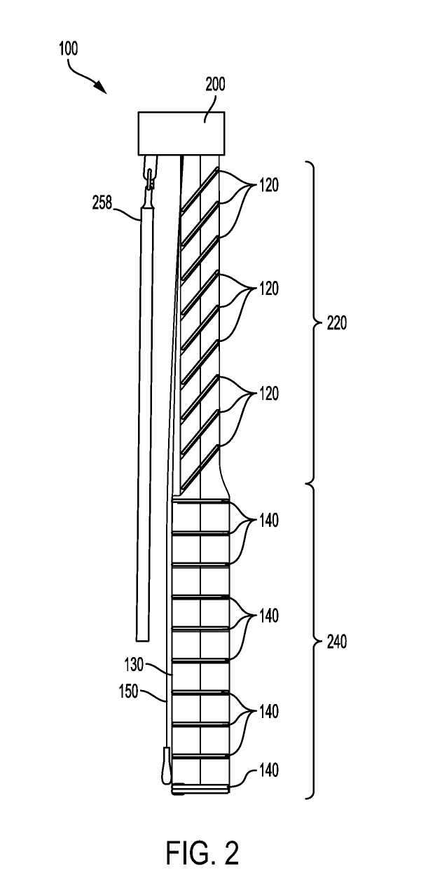

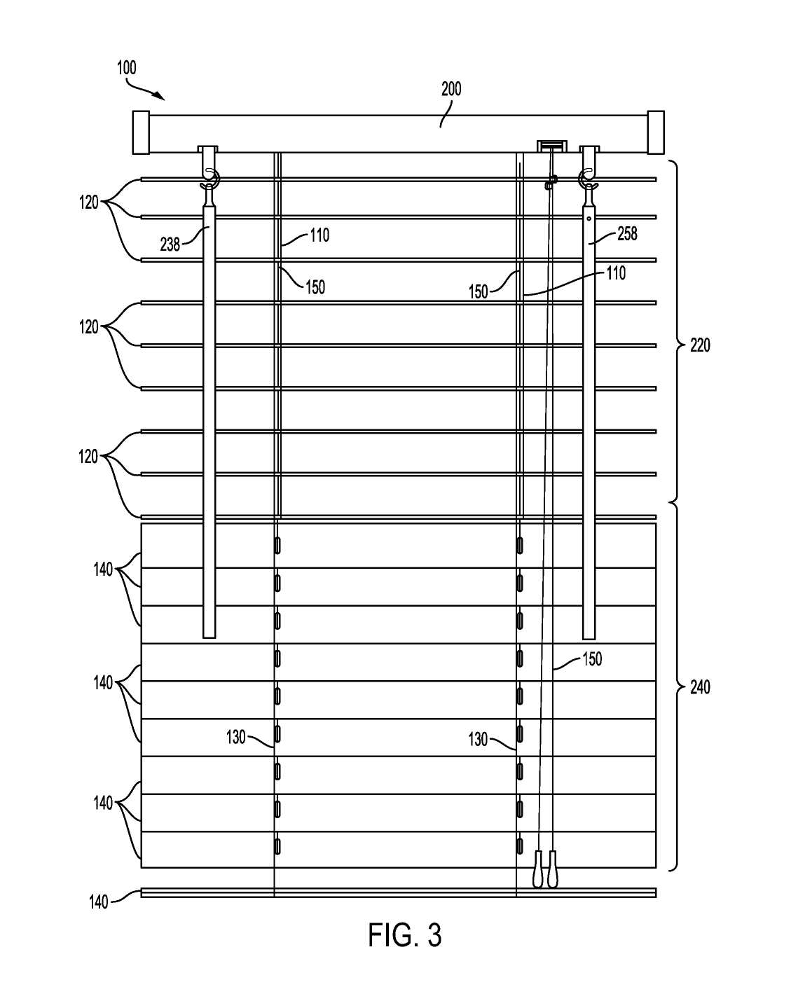

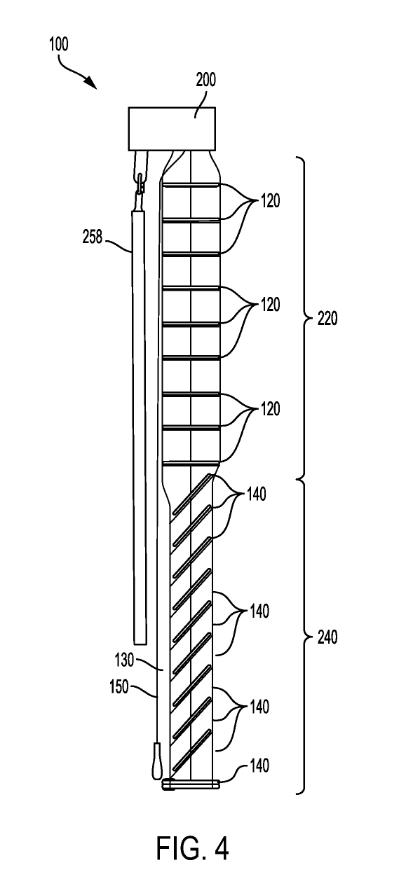

Each partition 220, 240 is independently operated. In one or more embodiments, a user will rotate a first wand 238 to rotatingly adjust the first set of slats 120, thereby opening or closing the first partition 220. Independently, a user may rotate a second wand 258 to rotatingly adjust the second set of slats 140, thereby opening or closing the second partition 240. A wand or any other suitable driver may be used to rotatingly adjust the first and second set of slats 120, 140 independently. For exemplary purposes, FIGS. 1-2 depict the first partition 220 in a closed position and the second partition 240 in an open position, while FIGS. 3-4 show the first partition 220 in an open position and the second partition 240 in a closed position.

The top partition rail 200 has guides and holes in an appropriate number and position that allow primary lift cords 150 to pass through to facilitate the lifting and lowering of the slats 120, 140 in each partition 220, 240. The primary lift cords 150 are coupled to a partition end rail 145, otherwise described as the lowest slat or a partition end slat, in the lowest partition. While the primary lift cords 150 may pass through holes in the slats 120, 140, the primary lift cords 150 may also pass vertically along the outer edge of the slats 120, 140. The number of primary lift cords 150 depends on whether the primary lift cords 150 pass through holes in the slats 120, 140 or travel along the outer edge of the slats. A minimum of two cords exist when the primary lift cords 150 pass through holes in the slats 120, 140 and four cords when the primary lift cords 150 pass along the outer edges of the slats 120, 140. In the present embodiment, the primary lift cords 150 pass through holes in the slats 120, 140.

The primary lift cords 150 are anchored at the partition end rail 145 in the bottom partition 240 and travel the total distance vertically to the top partition rail 200. Each primary lift cord 150 is gathered through guides and openings in the top partition rail 200 such that each primary lift cord 150 may be pulled simultaneously. Such guides and openings may have shaped surfaces which allow smoother, less use of force, and increasingly efficient movement of the strings or cords.

For each independently operating ladder system 110, 130, there may be a partition end rail 125, 145, otherwise described as a lowest slat of a partition or a partition end slat, which may have dimensions unique from the slats 120, 140 in the respective partition 220, 240 that help create increased stability and balance for the respective partition 220, 240 in the ladder system. For example, the partition end rail 125, 145 may be thicker than the other slats 120, 140 in the partition 220, 240 as to create stability in the respective partition 220, 240.

In one or more embodiments, the second partition 240 of slats 140 in the lower vertical position relative to the top partition rail 200 include front and back support cords 132, 134. The front and back support cords 132, 134 bypass the upper partition's slats 120 and connect to the slat control fixture 246 which independently operate its own ladder system 130. For any number of partitions that exist, the support cords will in the same manner bypass all partitions in a higher position. The support cord(s) of a lower partition are discretely guided upwardly past any number of partitions or groups of ladder systems above and connect to its slat control fixture. The support cords that bypass upper partitions periodically have horizontal connection cords that connect the front support cord to the rear support cord with a fit loose enough so that movement of the support cords do not interfere with the upper ladder system(s).

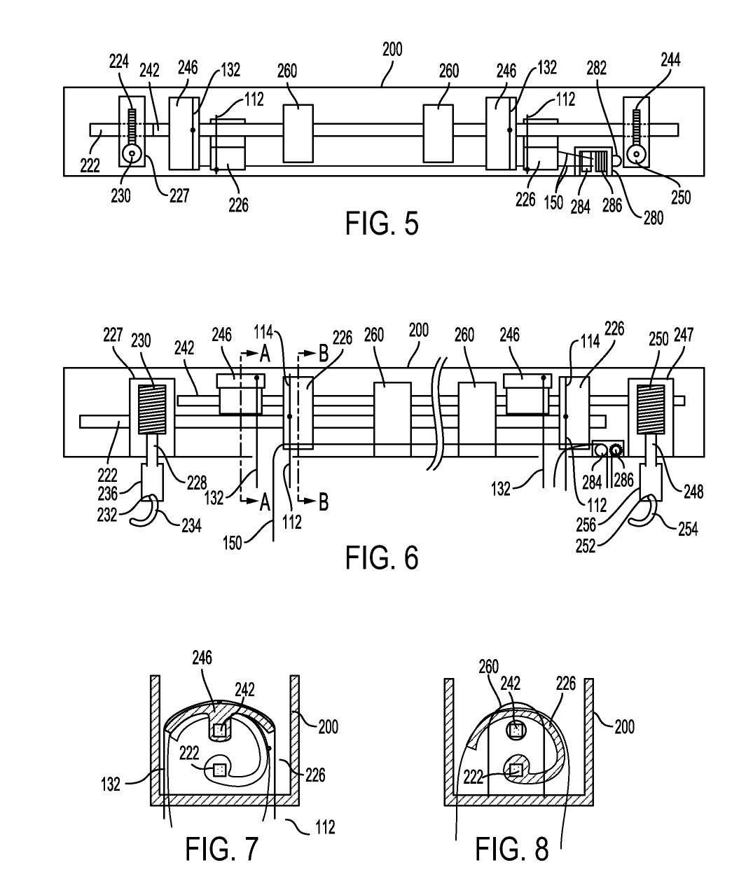

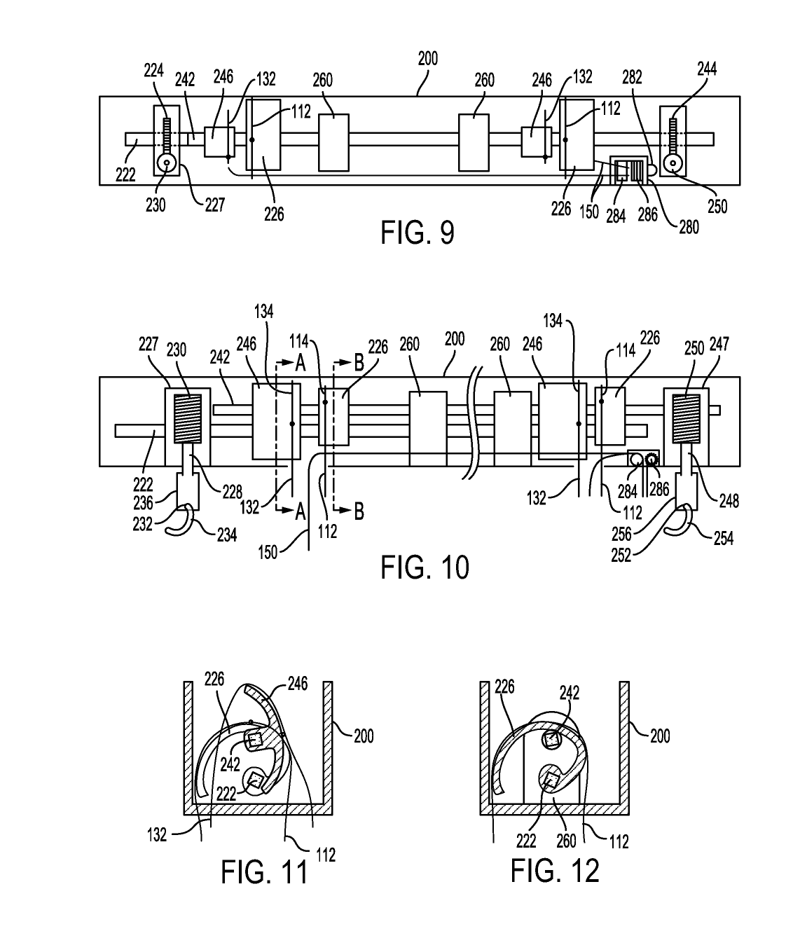

FIGS. 5-12 depict various views and configurations of the top partition rail 200. FIGS. 5-6 illustrate a top and side view respectively of the top partition rail 200, in which the first partition 220 is in the closed position and the second partition 240 is in the open position. The first partition 220 is independently controlled by a first partition system, the first partition system having the first ladder system 110, a first slat control fixture 226, a first shaft 222, a first worm gear 224, a first worm 230, a first arm 228, a first inset groove 232, a first hook 234, a first sleeve 236 and the first wand 238. The second partition 220 is independently controlled by a second partition system, the second partition system having the second ladder system 110, a second slat control fixture 226, a second shaft 222, a second worm gear 224, a second worm 230, a second arm 228, a second inset groove 232, a second hook 234, a second sleeve 236 and the second wand 238. In one or more embodiments, the top partition rail 200 has a rectangular, u-shaped construction, though it is to be understood that the top partition rail 200 may have any suitable size and shape.

The top partition rail 200 comprises the shafts 222, 242 that allow independent control and rotational movement of the set of slats 120, 140 in each respective partition 220, 240. In some embodiments, the shafts 222, 242 have a rectangular or square cross-sectional shape, but the shafts 222, 242 may any other shape suitable for transmitting rotation of the worm gears 224, 244 into rotation of the slat control fixtures 226, 246, respectively. Each worm gear 224, 242 allows each respective shaft 222, 242 to rotate one direction or the other.

In one or more embodiments, the shafts 222, 242 have supports 260. The supports 260 include a first aperture 262 that receives the first shaft 222 and a second aperture 262 that receives the second shaft 242. The supports 260 hold each shaft 222, 242 parallel to a longitudinal axis of the top partition rail 200, yet allow independent functioning and rotation of each shaft. Furthermore, supports 260 may accommodate any number of shafts. Any suitable materials such as plastic, metal, wood, or the like may be used to construct the supports 260. The shafts 222, 242 may also be supported in other ways such as by a housing assembly that comprises the supports 260 for the shafts 222, 242 and snaps into designated slots in the top partition rail 200. The housing assembly may be used, for example, to make the manufacturing process more cost and time efficient.

Each shaft 222, 242 has a respective slat control fixture 226, 246 coupled to the shaft 222, 242 that supports and has rotational control functionality of a respective ladder system 110, 130. There is one slat control fixture for each ladder system. Each slat control fixture 226, 246 is shaped so that, as it rotates about its respective shaft 222, 242, the slat control fixture 226, 246 causes its respective ladder system 110, 130 to move the slats 120, 140 to a fully opened or closed position or an intermediary position. In one or more embodiments, the first slat control fixture 226 is coupled to a front support cord 112 and a back support cord 114 of the first ladder system 110.

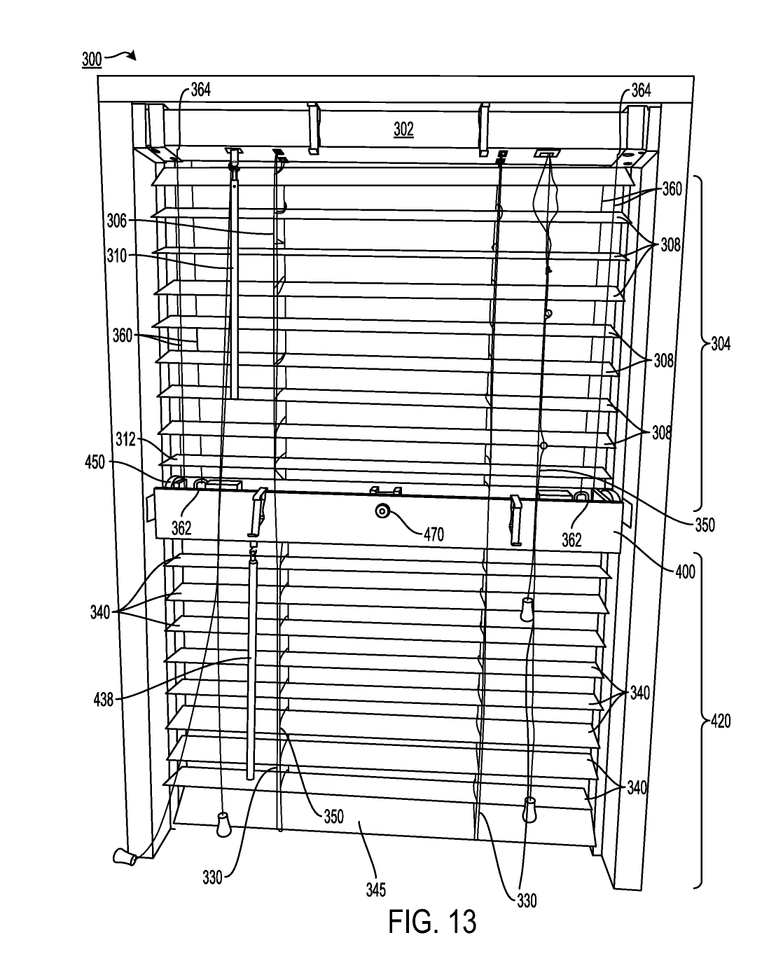

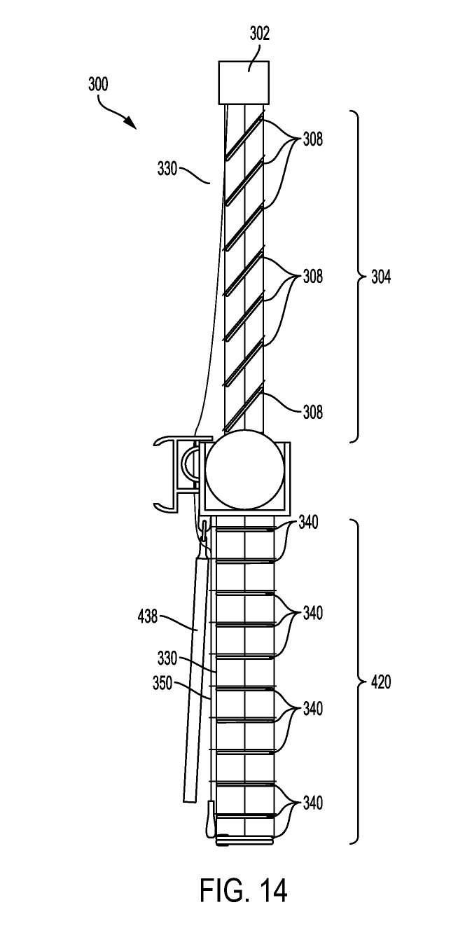

FIGS. 7-8 depict cross sectional views of the first slat control fixture 226 and the second slat control fixture 246, respectively. The slat control fixtures 226, 246 are sized in proportion to a width of the slats 120, 140 so that the slat control fixtures 226, 246 rotate through a predetermined degree of revolution to rotate the slats 120, 140 from a completely opened to a completely closed position, or vice versa. That is, the slat control fixtures 226, 246 do not make a complete revolution in order to move the slats 120, 140 in the ladder systems 110, 130 rotatingly to a completely opened or completely closed position. Such rotational movement occurs without the slat control fixture's 226, 246 path being obstructed by another shaft 222, 242. Each slat control fixture 226, 246 is shaped in such a manner so as to keep the ladder systems 110, 130 firmly connected to the slat control fixture 226, 246 and efficiently guide the direction and movement of the cords, rungs or tape in the ladder systems 110, 130. The top partition rail 200 has combinations of parts such as but not limited to gears, pulley systems, and the like that are attached to and/or works in conjunction with each shaft 222, 242 at a point and in a manner in which there is no interference with the slat control fixtures 226, 246 which support the ladder systems 110, 130.

Referring back to FIGS. 5-6, in some embodiments, each shaft 222, 242 is rotated by a respective worm gear 224, 244 held within a respective gear housing 227, 247. The gear housings 227, 247 are shaped to hold its gear components in place in a stable manner and yet allow the gear components to rotate or turn as needed to move and control the ladder systems 110, 130. It is to be understood that, while the present disclosure may refer to a singular gear housing, the description applies to both a first gear housing 227 and a second gear housing 247. In certain embodiments, the gear housing 227, 247 fits into the top partition rail 200 by snapping into place through use of the u-shaped structure of the top partition rail 200 and preset holes. The gear housing 227, 247 has a shape on an upper body that causes it to lock into place with a lip in the rectangular u-shape on a top of the top partition rail 200. A bottom of the gear housing 227, 247, at the point where an arm 228, 248 protrudes from the gear housing 227, 247, is shaped so that the bottom of the gear housing 227, 247 locks into a cutout in the top partition rail 200.

The gear housing 227, 247 has the worm gear 224, 244, which has a center shaped to accommodate the shaft 222, 242 such that when the worm gear 224, 244 rotates the shaft 222, 242 will also rotate. For example, the shaft 222, 242 may have a square cross section, and the worm gear 224, 244 may have a corresponding square aperture. It is to be understood that any suitable combination of shapes may be used to rotatingly couple each worm gear 224, 244 to each respective shaft 222, 242.

The gear housing 227, 247 further includes an arm 228, 248 with a worm 230, 250 on a first end and an inset groove 232, 252 near a second, opposite end. When the arm 228, 248 is rotated, the worm 230, 250 will also rotate and cause the worm gear 224, 244 to rotate and in turn cause the shaft 222, 242 to rotate. The arm 228, 248 extends beyond the gear housing 227, 247 on the second end having the inset groove 232, 252. A hook 234, 254 is coupled to the arm 228, 248 at the inset groove 232, 252 and is held in place by a sleeve 236, 256. The arm 228, 248 extends outward from the gear housing 227, 247 and passes through a portion of the front and bottom of the top partition rail 200. The hook end of the arm 228, 248 protrudes out of the top partition rail 200 so that a looping part of the hook 234, 254 is exposed. A wand 238, 258 is attached to the hook 234, 254.

The shaft 222, 242 controlled by the respective gear housing's 227, 247 components passes through a middle of each respective worm gear 224, 244 with a snug fit. When adequate force is applied causing the wand 238, 258 to turn, the arm 228, 248 with the worm 230, 250 rotates and causes the worm gear 224, 244 to rotate—which in turn causes the shaft 222, 242 to rotate. It is to be understood that any suitable number of combinations of parts including gears, pulleys, sprockets, springs, and the like may be used that will work in conjunction with one another to create any number of methods which ultimately cause the shaft 222, 242 to move rotatingly when adequate force is applied. Adequate force is applied to such combinations of parts in the gear housing 227, 247 through the use of string, cord, wand, or some other means that facilitates the movement of the combination of parts, including electricity, remote control devices, and the like. The rotational movement of each shaft 222, 242 causes each respective slat control fixture 226, 246 on the same shaft 222, 242 to move rotatingly, which in turn causes the slats 120, 140 in the respective ladder system 110, 130 to move rotatingly to an open or close position. In one or more embodiments, the slats 120, 140 are in a horizontal orientation.

In some embodiments, the top partition rail 200 includes a guide housing 280 for the primary lift cords 150. After entering the top partition rail 200, each primary lift cord 150 is gathered at a single opening guide at the bottom of the top partition rail 200 in a manner that is clear of the operational shafts 222, 242 and slat control fixtures 226, 246. The guide is a guide housing 280 that is comprised of an elongated bent u-shaped metal pin rail 282, a bar 284, and a gear 286. The gear 286 rests upon the bent u-shaped pin rail 282 and allows a back and forth rolling. The bent u-shaped pin rail 282 also holds the guide housing 280 in place on the top partition rail 200. The bar 284 is fixed in a position across and perpendicular to the direction of the bent u-shaped pin rail 282. The primary lift cords 150 are gathered and passed in between the bar 284 and the gear 286. The rolling and rotating motion of the gear 286 allows the primary lift cords 150 to pass upwards or downwards when appropriate force is applied to the primary lift cords 150. When the application of force is halted, the gear 286 comes to rest toward a bottom portion of the bent u-shaped pin rail 282 and catches the primary lift cord 150 between the gear 286 and the bar 284. The partitions 220, 240 are thereby supported and held at a point. In other embodiments, options for the primary lift cords include the use of spools, pulleys, gears, and the like which may be combined to work in conjunction with one another in various combinations to create advantageous ratios whereby the user will pull on the primary lift cords 150 thereby lifting the system of partitioned blinds without bearing the full weight through the primary lift cords 150 and applying less force to the primary lift cords 150 because of the advantage. The force applied may be manual or by some other method such as electric, remote control device, a combination of such forces, or any other suitable method.

In one or more embodiments, a method of independently controlling multiple operational blind partitions proceeds with the user moving the blinds to a fully extended position by momentarily applying a downward force on the primary lift cords 150 that disengages the gear 286 from the primary lift cords 150. Once the lift cords 150 are disengaged from the gear 286, the user reverses direction and allows the force of gravity to pull both partitions 220, 240 of blinds downward until the partitions 220, 240 are in a fully extended position. The primary lift cords 150 are released, and if the second partition end rail 145 is not resting on the bottom of the architectural opening, the user releases the primary lift cords 150 so that the associated gear 286 locks the primary lift cords 150 into place.

After both partitions 220, 240 are in a fully extended position, the user opens the first partition slats 120 by applying force to rotating the wand 238 that is connected to the hook 234. As the hook 234 turns, the arm 228 turns the worm 230 which causes the worm gear 224 to rotatingly turn. The rotating movement of the worm gear 224 causes the attached shaft 222 to rotate about. Thus the slat control fixture 226 rotates about on the shaft 222 without the slat control fixture's 226 path of movement being interfered with by the second shaft 242 which is used in the operation of the lower partition 240. For example, if the user desires the first partition 220 to have its slats 120 open, the user continues rotating the wand 238 until the slats 120 are in the open-most position allowing the maximum amount of light entry through the slats 120 in the architectural opening.

The user then rotates a separate wand 258 to operate the second partition 240. As adequate force is applied causing the wand 258 for the second partition 240 to rotate, the hook 254 rotates and in turn causes the arm 248 to rotate. As the arm 248 rotates the worm 250 on its first end, the worm gear 244 rotates which in turn causes the second shaft 242 to rotate. The shaft 242 for the second partition 240 rotates about and causes the slat control fixture 246 to rotate through a substantially equal degree of rotation. The slat control fixture 246 on the shaft 242 of the second partition 240 rotates about in such a manner that its path of rotation is not impeded by the shaft 222 of the first partition 220. The user continues rotating the wand 258 until the slats 140 in the second ladder system 130 are moved to a closed position. The user now has the privacy of the slats 140 being closed on the lower second partition 240, yet has the maximum sunlight coming through the opened slats 120 of the upper first partition 220.

The user may choose to do the opposite for each partition 220, 240 or any combination of degree of openness or closeness in between relative to the rotational movement of each respective wand 238, 258 and ultimately the rotational movement of the slat control fixtures 226, 246. All parts used to make or manufacture partitioned blinds in the present disclosure may be grouped in such a way as to ease and optimize mass production of the partitioned blinds. The partitions may be made to align with the window slats of an architectural opening or aligned in some other manner.

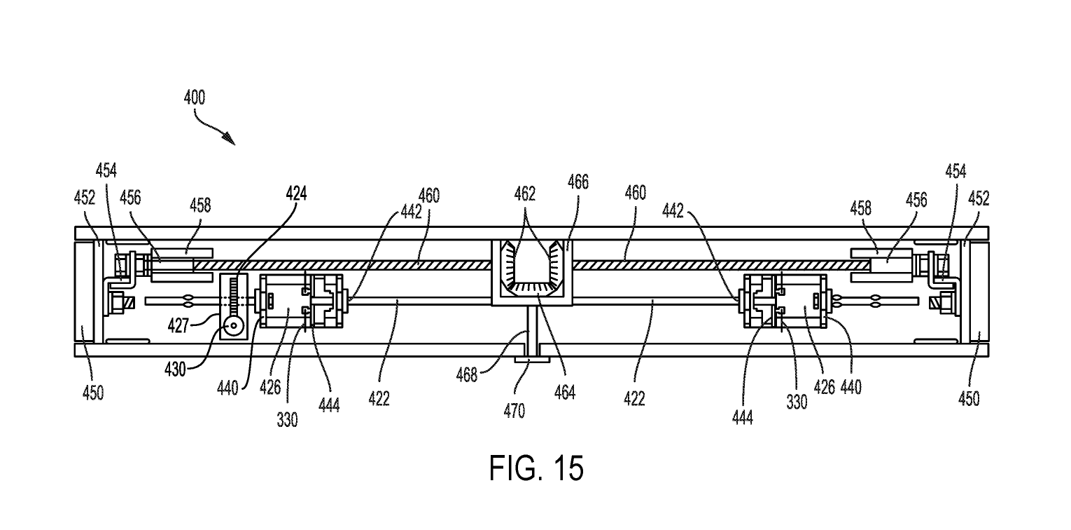

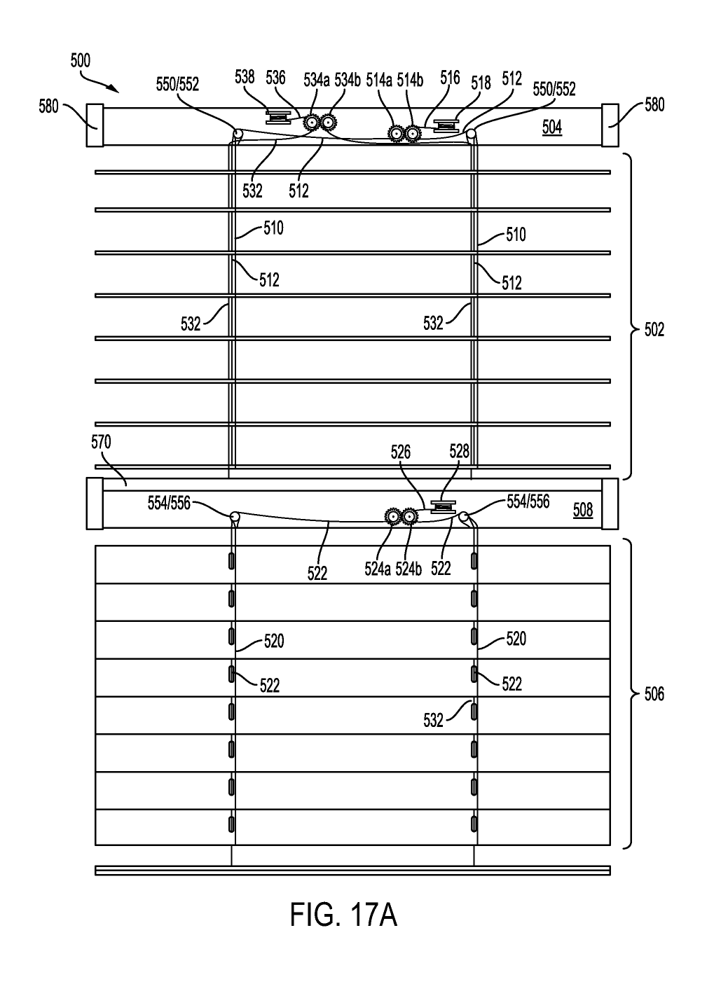

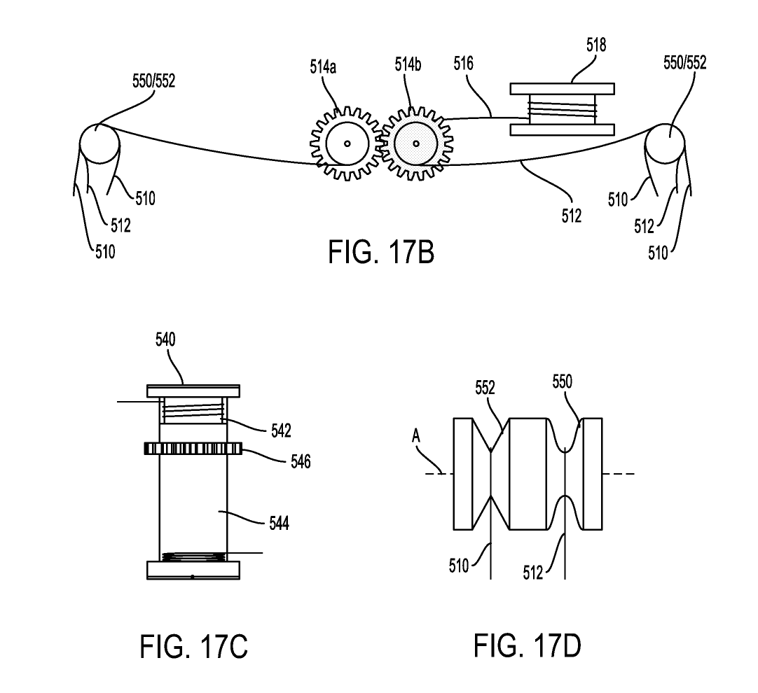

FIGS. 9-12 illustrate the top partition rail 200 in which the first partition 220 is in the open position and the second partition 240 is in the closed position. As shown and described above, the slat control fixtures 226, 246 rotate to control the vertical offset of the front support cords 112, 132 from the back support cords 114, 134 of each respective ladder system 110, 130. The first slat control fixture 226 rotates independently from the second slat control fixture 246. As shown by the cross sectional views in FIGS. 11-12, each slat control fixture 226, 246 can rotate without interference from the opposite shaft 242, 222 through the complete degree of revolution necessary to move the slats 120, 140 from a completely open position to a completely closed position.

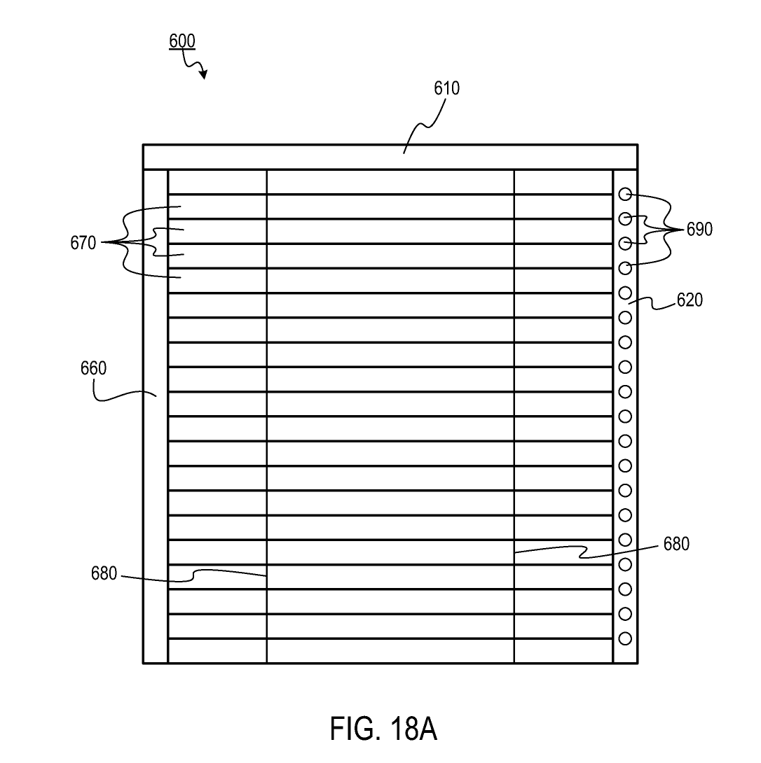

FIGS. 13-16 show another example of an embodiment of a multi-partition blind system 300 that uses a mechanism referred to in the present disclosure as a middle partition rail, or a midrail 400. The term midrail is used here, but the nature and likes of the midrail may be called by any other suitable name. The midrail 400 and its internal elements are made from materials such as plastic, metal, wood, nylon, or any other suitable material that is durable, suiting, and cost efficient in the manufacturing process. Any number of midrails 400 may be placed where partition boundaries are desired in an architectural opening. Each partition may have a partition end rail or a partition bottom rail.

The midrail 400 may be installed at varying points such as during the manufacturing process in which multiple partitions are created, or on pre-existing blinds in which multiple partitions are desired. For example, if midrails are installed on pre-existing blinds, a ladder system with slats and a partition end rail or partition bottom rail may be provided along with the midrail 400 to ease and facilitate the installation and operational process. Whether installed on pre-existing blinds or installed during the manufacturing process, the midrail 400 may be adjustable to various positions relative to the architectural opening.

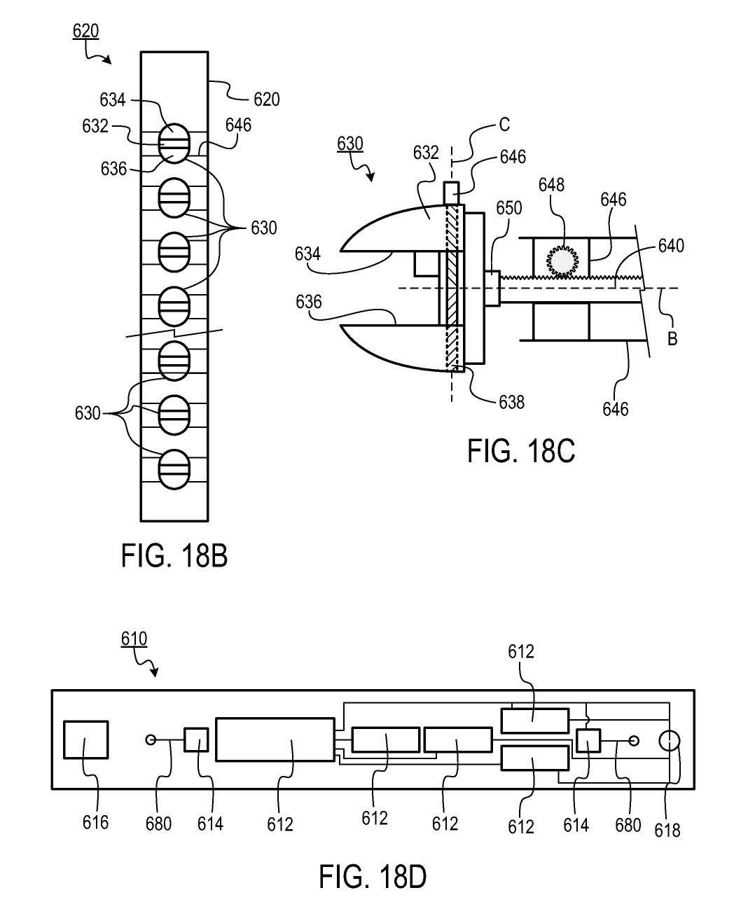

FIGS. 13-14 show the midrail 400 having an independent midrail partition 420 having a ladder system 330 that supports a set of slats 340. The midrail partition 420 is independently operated from a top partition rail 302 having an upper partition 304. In one or more embodiments, a user will rotate a midrail wand 438 to rotatingly adjust a set of slats 340 in a ladder system 330, thereby opening or closing the midrail partition 420. Independently, a user may rotate a top wand 310 to rotatingly adjust a top set of slats 308, thereby opening or closing the upper partition 304. Similar to the previous embodiments, the upper partition 304 may comprise a partition end rail 312 to create stability for a top ladder system 306.

In certain embodiments, the midrail 400 has the same u-shaped structure as the top partition rail 200 and may have an openable and closeable top. The top, when opened, allows access to an internal chamber of the midrail 400. The top, when openable, is securely closed by turning latches, fasteners, or the like, which lock with the u-shaped body of the midrail 400. The midrail top has an appropriate number of latches, fasteners, or the like, relative to the materials used to construct the midrail and the length of the midrail as it transverses an architectural opening horizontally. That is, the wider the architectural opening, the more latches or fasteners may be used. The latches, fasteners, and the like, are sufficient in number and/or strength to preclude the midrail top from having gapped openings at the point where the midrail top meets the body of the midrail 400. It is to be understood that the midrail 400 may have closed or opened upper portion with or without an openable and closable top.

A number of primary lift cords 350 will vary based primarily on whether the primary lift cords 350 are passing through holes in the slats 308, 340, or alongside the outer edge of the slats 308, 340. A minimum of two primary lift cords 350 are used when the primary lift cords 350 pass through holes in the slats 308, 340, and a minimum of four are used when the primary lift cords 350 pass along the outer edge of the slats 308, 340. The primary lift cords 350 are anchored at a partition end rail 345 in the lowest partition, the midrail partition 420 as shown in FIGS. 13-14, and move upwardly through holes in the slats 308, 340 and pass through guides in the top partition rail 302.

After entering the top partition rail 302, each primary lift cord 350 is gathered at a single opening guide at the bottom of the top partition rail 350 in a manner that is clear of the operational shafts and slat control fixtures for the upper partition 304. The guide may be structured as the guide 280 previously shown and described in FIGS. 5-6. The guide is a housing that is comprised of an elongated bent u-shaped metal pin rail, a bar, and a gear. The gear rests upon the bent u-shaped pin rail in a manner which allows a back and forth rolling. The bent u-shaped pin rail also holds the guide housing in place on the top partition rail 302. The bar is fixed in a position across and perpendicular to the direction of the bent u-shaped pin rail support. The primary lift cords 350 are gathered and passed in between the bar and the gear. The rolling and rotating motion of the gear allows the primary lift cords 350 to pass upwards or downwards when appropriate force is applied to the primary lift cords. When the application of force is halted, whether the lift cords are in use to cause the partitions 304, 420 of slats 308, 340 to be lifted or lowered, the gear eventually comes to rest toward the bottom portion of the bent u-shaped pin rail and catches the cord between said gear and the bar thereby causing the partitions 304, 420 to be supported and held at a point. Other options for the primary lift cords 350 include the use of spools, pulleys, gears, and the like which may be combined to work in conjunction with one another in various combinations to create advantageous ratios whereby the user will pull on the primary lift cords 350 thereby lifting the system of partitioned blinds without bearing the full weight through the primary lift cords 350 and applying less force to the primary lift cords 350 because of the advantage. The force applied may be manual or by some other method such as electric, remote control device, a combination of such forces, or some other method.

The midrail 400 has a series of support cords 360 coupled to support cord anchor points 362. The support cord anchor points 362 can be moved and positioned to accommodate various pre-existing sizes of blinds and also accommodate both blinds that have the primary lift cords 350 pass through holes in the slats 308, 340 or primary lift cords 350 that travel along the edge of the slats 308, 340. The number of support cords 360 employed on the midrail 400 also depends on the distance across the midrail 400 to suitably fit a given architectural opening. The more distance across the midrail 400, i.e. the wider the architectural opening, the more support cords 360 that will be employed. The optimal number of support cords 360 is typically the same number of tapes or ladders in the tape or ladder system 330 employed in a given instance relative to the size of an architectural opening.

Midrail support cords 360 travel upwards to the next midrail 400 or if none are present, to the top partition rail 302. If the support cords 360 connect to another midrail 400, the midrail 400 has an accommodating attachment points where the support cords 360 are attached. If the midrail support cord 360 is attached to and supported by a head rail such as those well-known and defined in the art, an attachment device is supplied to the head rail for each connection point 364. For attachment points on both the top partition rail 302 and midrail 400, unique guides are used to control the direction the support cords travel. When the support cords 360 are connected to the connection points 364, located on either another midrail or a top partition rail 302, the supported midrail 400 hangs suspended and supports the midrail partition 420 of the ladder system 330 having the slats 340. Top partition rails 302 may be generally manufactured to accommodate the attachment and supporting of subsequently added midrails 400.

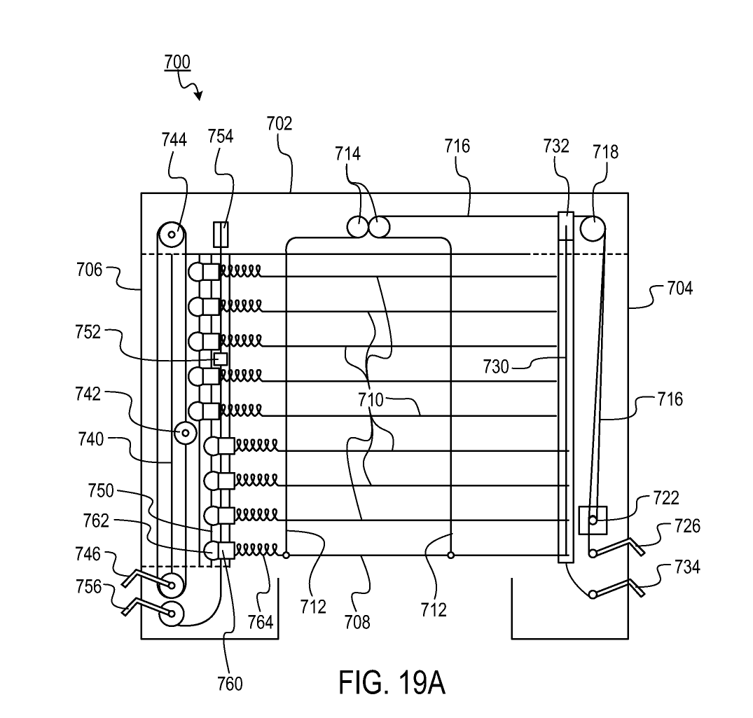

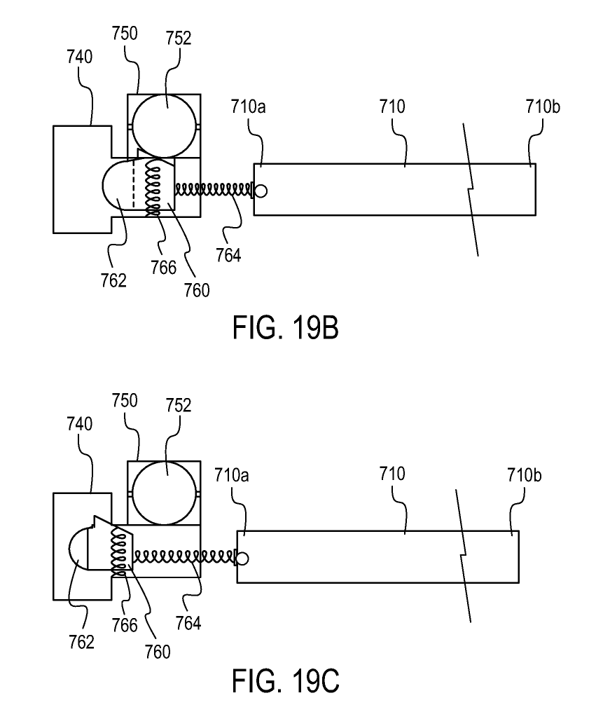

FIGS. 15-16 illustrate the midrail 400 comprising a unique combination of slat control fixtures 426 and housings 440 upon which such slat control fixtures 426 are coupled. A rotatingly movable shaft 422 passes and fits snugly through a hole 442 in the slat control fixtures 426. The shaft 422 may be rectangular in shape, or any other suitable shape for rotatingly engaging hole 442. The midrail 400 has a gear housing 427 that comprises a worm gear 424, a worm 430 with an extended arm 428 and a grooved inlet 432 where a hook 434 is attached and held in place with a sleeve 436. A wand 438 is attached to the looping end of the hook 434 where a user applies force which allows the ladder system 330 in the respective partition 420 to independently operate.

In some embodiments, the slat control fixtures 426 are sized in relation to the size of the slats 340 such that the slat control fixtures 426 do not make a complete revolution when rotatingly moving to cause the ladder system 330 to move its slats 340 to an open or closed position. That is, the slat control fixture 426 rotates through a predetermined degree of revolution to rotate the slats 340 from a completely open position to a completely closed position. The slat control fixtures 426 are connected to the shaft 422 made of materials such as plastic or metal, for example, or other suitable durable material. The slat control fixtures 426 are shaped to allow support cords 360 and primary lift cords 350 to pass through the midrail 400 and the slat control fixtures 426 without precluding or impeding the rotational movement of the slat control fixtures 426. The number of slat control fixtures 426 present in any midrail 400 depends on a distance the midrail spans across an architectural opening, the desired number of ladders in a system of ladders, or the pre-existing number of ladders in a ladder system.

The shaft 422 further connects to the gear housing 427 which has the worm gear 424, the worm 430 with the arm extension 428, the grooved inlet 432, and the hook 434 connected to the grooved inlet 432 that is covered by the sleeve 436. The arm 428 extends outward from the gear housing 427 and passes through the bottom and front of the midrail 400. The gear housing 427 has a shaped upper portion coupled to a lipped portion of the midrail 400 which allows it to hold in stable position. The hook 434 is attached to an end of the arm 428 opposite the worm 430 and is held in place by the sleeve 436. A wand 438 is coupled to the hook 434 to provide a point at which force may be applied. There are numerous other combinations of parts that will accomplish similar functionality that may include the use of pulleys, spools, and the like. When force is applied to the wand 438, the arm 428 and worm 430 rotate and cause the worm gear 424 to rotate. The worm gear's 424 rotating movement causes the shaft 422 to turn rotatingly. When the shaft 422 turns rotatingly, the slat control fixtures 426 move rotatingly and in turn cause the tape or ladder system 330 to tilt the slats 340 to an open or closed position or some intermediate position in only the subject partition 420.

The midrail 400 may have unique guides 444 that facilitate the movement of tapes or cords such as those in a ladder system. The guides 444 facilitate smooth movement and control of the ladder system. In some embodiments, the guides 444 may also be a part of a support or slat control fixture housing 440, and/or other parts that may snap, twist, turn, and/or lock into place with the structure of the midrail 400 which create higher efficiencies in the manufacturing process. The guides 444 and the support or slat control fixture housing 440 are also made so as to avoid any restriction of movement of primary or secondary lift cords or support cords that pass through the midrail 400.

A top portion and a bottom portion of the midrail 400 may have holes, or knockouts where holes can be made, which align with the primary lift cords 350 of the blinds (or the lift cords previously known in the art) and the ladders of the blinds. In certain embodiments, the holes or knockouts that may be present for ladders of blinds are used with midrails 400 that are installed on pre-existing blinds. The midrail 400 may have slotted openings or some other form of guides which allow primary lift cords 350 to pass along the edge of the midrail 400, as shown in FIGS. 13-14, when the primary lift cords 350 pass along the edge of slats 308, 340 rather than through the top and bottom of the midrail 400. Midrails 400 may be manufactured with slotted openings or guides of some other form or guides may be manufactured so that such guides may be attached to the midrail and serve the same purpose.

Referring back to FIGS. 15-16, each midrail has two fittings 450 located at both ends of the midrail 400 that move outwardly and inwardly. Moving the fittings 450 outward creates pressure against a vertical side wall or edge of an architectural opening such that the midrail 400 is stationary and stable at a desired location. Moving the fittings 450 inward releases the pressure and allows the midrail 400 to hang in suspension via the support cords 360.

There are various methods that may be employed to cause the fittings 450 to move. In one example, a shaft 460 has a first, threaded end coupled to a rectangular shaped elongated nut 456. The nut 456 is held in place by a similarly rectangular shaped hollowed recess 458 of the midrail 400. The hollowed recess 458 prevents the elongated nut 456 from rotating, thus the rectangular shaped nut 456 slides back and forth along a longitudinal axis of the shaft 460 as the outer threaded ends of the shaft 460 rotate through the receiving threads of the nut 456. The opposite end of the rectangular shaped nuts 456 has a flattened surface area 452 with a curvature support 454 moving away from the side of the surface area 452 nearer to the shaft 460. The fitting 450 may be a rubber or sufficiently stiff foamed outer fitting, or a fitting made with and/or covered by some other durable and appropriate material. The fitting 450 is attached to the surface area 452 on the surface area end of the rectangular nuts 456. In certain embodiments, the fittings 450 are about the same size as the surface area 452. The turning of the shaft 360, and thereby the threaded ends, cause the nut 456 to move outwardly or inwardly, depending on the direction the threads are turning.

In one or more embodiments, the shaft 460 has a first bevel gear 462 at a second end. A second bevel gear 464 is engagingly secured to the first bevel gear 462 within a housing 466 of the midrail 400. The first bevel gear 462 is coupled to a shaft 468 having a driving recess 470. The user can move the fittings 450 outward or inward by using a driver to rotate the driving recess 470. When adequate and appropriately directed force is applied to the driving recess 470, the first bevel gear 462 rotates via the shaft 468 and rotatingly engages the second bevel gear 464. The shaft 460 rotates via the second bevel gear 464, which applies an outward or inward force on the threads of the rectangular nut 456. The rectangular nut 456, and thus the curvature support 454 and surface area 452, moves outward or inward, causing the fitting 450 to either create pressure against the architectural opening or release pressure.

In some alternative embodiments, the shaft 460 has a worm gear on it. A worm is held together with the worm gear inside a housing which is affixed to the midrail. The worm has a shaft and handle. The shaft may have an attachment that allows the handle to swing open and be discretely closed into the midrail 400. The handle allows a user to apply a force causing the worm to turn. As such adequate and appropriately directed force is applied to the handle that is attached to and/or a part of the worm, the worm turns and causes the worm gear to turn thereby causing the shaft 460 with threaded ends to turn. The turning of the threads moves the rectangular nut 456 outwardly or inwardly, depending on the direction the shaft 460 is turned. The outward movement causes the fittings 450 ultimately to press against some point on the vertical sides of an architectural opening and cause the midrail 400 to become stable in position. A similar force in the opposite direction is applied causing the shaft 460 to turn in the opposite direction causes the fittings 450 to move inwardly releasing the pressure on the fittings against the sides of the architectural opening thereby allowing the midrail 400 to hang suspended and supported by either by the top partition rail 302 and/or any other midrails 400 that exist between the top partition rail 302 and the subject midrail 400.

It is to be understood that the elements coupling the driving recess 470 or handle to the fitting 450 on one side of the midrail 400 similarly may be used on the other side of the midrail 400. As shown in FIGS. 15-16, the second bevel gear 464 couples to two first bevel gears 462, one for the fitting 450 on a first end of the midrail 400 and one for the fitting 450 on a second end of the midrail 400. As the driving recess 470 is rotated, both first bevel gears 462 rotate through a substantially similar degree of revolution, and cause both fittings 450 to extend or retract a substantially similar distance.

Referring back to FIG. 13, operationally, the presence of midrails 400 in blinds create separate partitions 304, 420 which allow the ladder systems 306, 330 to move slats 308, 340 rotatingly to an opened, closed, or intermediate position independently. For each midrail 400 present, there is a separately functioning partition 420 of a ladder system 330. Blinds with horizontal slats may be partitioned using midrails 400 either during the manufacturing process or after the user has purchased blinds that were not partitioned.

In a first example where there are two partitions 304, 420 created during the manufacturing process, the multi-partition blind system 300 will have one top partition rail 302 and one midrail 400. The midrail 400 will be located at a desirable point. For example, the midrail 400 may hang approximately midway between a top and a bottom of an architectural opening it will be used to cover. In such example, the midrail 400 essentially creates an upper partition 304 for upper window slats 308 and a midrail partition 420 for midrail slats 340.

The midrail 400 is comprised of the unique parts as earlier described. The support cords 360 of the midrail are connected to the attachment points 364 on the top partition rail 302. The top partition rail 302 is manufactured with accommodating attachment points 364 where the midrail 400 is connected. The top partition rail 302 supports the upper partition 304, the ladder system 306 and the slats 308, as well as the midrail 400, the midrail partition 420, the ladder system 330 and the slats 340. The upper partition 304 has a partition end rail 312, which adds stability to the upper partition 304 and the ladder system 306. The midrail partition 420 has a partition end rail 345 which adds stability to its ladder system 330.

After installation, for additional stability, the user may apply force to the driving recess 470 or handle which will cause the midrail fittings 450 to move outwardly and tighten against some part of the sides of the architectural opening. The tightening of the fittings 450 will cause increased stability to the midrail 400 and the midrail partition 420.

Whether cords, strings, a wand, or some other means is employed, the tape or ladder system 330 and slats 340 in the midrail partition 420 may be moved rotatingly to an open or closed position. As shown in FIGS. 13-16, the user applies force to turn the wand 438 rotatingly. As the wand 438 turns rotatingly, the hook 434 and arm 428 turn the worm 430 which causes the worm gear 424 to rotatingly turn the shaft 422 that passes through the opening of the worm gear 424. As the shaft 422 turns, the slat control fixtures 426 rotate causing the slats 340 in the ladder system 330 to move to an open or closed position or some intermediary position. It is to be understood that a similar mechanism coupled to wand 438 may be coupled to wand 310 and disposed within the top partition rail 302 for operation of the upper partition 304.

To lift or lower both partitions 304, 420, if the fittings 450 have been moved to an outward position to create pressure against the vertical edge of the architectural opening, the fittings 450 will be first released by applying sufficient force to the driving recess 470 or handle which will cause the shaft 460 to turn and move the rectangular nut 456, thereby pulling the fittings 450 away from the sides of the architectural opening. The midrail 400 then would hang in a suspended state. The primary lift cords 350 are then anchored at the partition end rail of the lowest partition, or as shown in FIG. 13 the partition end rail 345 of the midrail partition 420. Applying adequate force to the primary lift cords 350 on the opposite end in which the primary lift cords 350 are anchored at the lowest partition end rail will cause the ladder system 330 of slats 340 to gather upwards with the midrail 400. When both partitions 304, 420 are fully lifted, the ladder system 330, including the midrail 400, and the ladder system 306 of slats 308 of the upper partition 304 will be gathered up toward the top partition rail 302. To lower the partitions, an opposite force is employed (or released) which allows the primary lift cords 350 to release and extend both partitions 304, 420, ladder systems 306, 330 and slats 308, 340, including the partition end rails 312, 345.

The upper partition 304 and the midrail partition 420 are each independently operated in the same manner as previously described by applying force to each respective wand 312, 438, as an example. The slats 308 in the upper partition 304 may be tilted, for example, to an open position to allow maximum light to pass through an architectural opening. The slats 340 in the midrail partition 420 controlled through the midrail 400 may be tilted, for example, to a fully closed position creating privacy at the same time light is passing through the upper partition 304. Each partition's slats 308, 340 may be opened or closed to the user's desired positions within the range of movement defined by slat control fixtures in the top partition rail 302 and the slat control fixtures 426.

In a second example, the midrail 400 is installed into pre-existing blinds to create two partitions. In this example, the ladder system of slats in either the upper partition or the lower partition may be opened or closed independently of one another. In one or more embodiments, the midrail 400 is installed by first determining the desired location for the midrail 400 to be positioned within the existing blinds. While the blinds are in position in the architectural opening, the lowest slat that will be a part of the upper partition is marked. The ladder system is cut three slats below the point where the end rail of the upper partition will located. From the remaining slats, the bottom four are removed. A partition end rail is added to the ladder system that will now serve to stabilize the ladder system of the upper partition. As a variation, the user may opt not to employ a partition end rail and leave the last slat in its place.

A midrail 400 is placed in the architectural opening just below the upper partition. The midrail 400 may have an equal number of ladders in the ladder system 330 with slats 340 included, and with the ladder system 330 with slats 340 included matching in location with the pre-existing ladder system. End fixtures 450 of the midrail 400 are turned outwardly by applying force at the driving recess 470 or handle. With the midrail 400 held in a stable state, the midrail's support cords 360 are passed through the holes in each slat in the upper partition. The support cords 360 are connected to attachment supports in the head rail, which will be used in lieu of a top partition rail 302, but serve in a similar manner. This example assumes the pre-existing blinds were comprised only of the head rail which previously existed in the art, and not a top partition rail 302 that is a part of the present disclosure. The support cords 360 remain essentially straight and perpendicular to the floor as the support cords 360 pass through the upper partition and upwards to the attachment point on the converted head rail. The attachment points on the converted head rail allow for the adjustment of the height of the midrail 400 relative to the spacing that exists between the partition end rail or lowest slat of the upper partition and the top of the midrail in the lower partition.

The lower partition ladder system may be adjusted as necessary by eliminating an appropriate number of slats so that the upper and lower partitions cover the architectural opening as the user desires. This is accomplished, as for one example, by cutting the ladder system at the appropriate point, sliding in the lower partition's partition end rail, and securing the ladder system to said lower partition's partition end rail. The primary lift cords are also securely attached to the partition end rail of the lower partition.

In an alternative example of a midrail 400 installed into pre-existing blinds, the midrail may come to the user with a ladder system without slats, or without a ladder system. In such instances, the ladder system and slats from the pre-existing ladder system may be used to the extent necessary. The upper partition is created by marking the ladder system and cutting each ladder allowing adequate slack. If a partition end rail for the upper partition is desirable, the lowest slat is replaced with a partition end rail. The present disclosure may also include reinforcing clear plastic corners that may be applied to each corner section where the ladder system was cut. The midrail 400 is placed just below the lowest slat or the partition end rail and the fittings 450 are moved outwardly to create pressure and stabilize the midrail 400 so that the midrail is essentially level across the architectural opening and parallel to the floor. The top of the midrail 400 is opened.

There are numerous methods for attaching ladder systems to the midrail. New ladder systems may be provided, for example. In the current description, the pre-existing ladder system is used. Short starter strings are attached to the slat control fixtures 426 of the midrail 400. If a slat control fixture housing 440 is used, the housing 440 may have control devices which allow upward or downward adjustments of the individual ladders in the ladder system. Adjustable parts at an end of the short starter strings can loosen to allow at least two cords through and tighten to clamp cords together securely so that the lower partition will be adequately supported. The cords from the ladder system where the cuts were made are threaded through the adjustable parts and tightened securely. Adjustments may be made at the fixture housing so that the top slat is positioned in a manner where it can rotate about into either a completely opened or closed position or all points in between.

After connecting each part of the ladder system to the midrail 400, the slats are placed into the ladder system. If necessary, slats may be removed from the lower partition so that the bottom slat drops to the desired point. A partition end rail may be used to replace the pre-existing bottom slat. The midrail support cords 360 are threaded through the holes in the slats in the upper partition and affixed to attachment supports on the converted head rail. Top partition rails may be manufactured with attachment supports that will adequately support midrails and accommodate the midrail support cords. Add-on attachments are supplied to convert pre-existing head rails into converted head rails that will function with multiple partitions that include a midrail 400.

If there are no holes in the slats, the support cords 360 are passed along the outer edge of the slats in the upper partition. The primary lift cords may be passed through the midrail 400 via knockout holes and threaded through the slats in the lower partition and anchored at the partition end rail or bottom slat. Alternatively, the primary lift cords may be passed along the edges of the slats through guides or slots in the midrail and anchored to the bottom slat or the partition end rail. The midrail top is closed and all latches locked into place.

Operationally, all of the midrail 400 installations will essentially work in the same manner. Any number of partitions may be created. In the examples given, the upper partition will have a ladder system of slats which functions independently of the lower partition's ladder system of slats.

In one or more embodiments of the present disclosure, each partition 420 in which there are horizontal slats 340 may have its own secondary lift cords. Unique guides, spools, sprockets, and the like may be combined in such a manner as to derive a ratio advantage where the user does not bear the full weight of the tape or ladder system 330. At a minimum, the secondary lift cords have enough length so that the cords travels from a point accessible by the user through a unique locking mechanism onwards through unique or combination guides and downward either through holes in the slats or along the edge of the slats. The secondary lift cords are attached to the partition end rail 345 in the partition 420 they control. The number of secondary lift cords used in some instances depends on whether or not there are holes in the slats 340 or if the lift cords will pass along the edge of the slats 340. At a minimum, the secondary lift cords are gathered in the same manner as the primary lift cords and have a similar housing and locking mechanics. In cases in which there are more than two partitions, the primary lift cords will travel from the top partition rail or a converted head rail downward and attach to lowest partition's end rail. If midrails 400 are used, the primary lift cords will pass through slots or guides along the edge of the midrail 400.

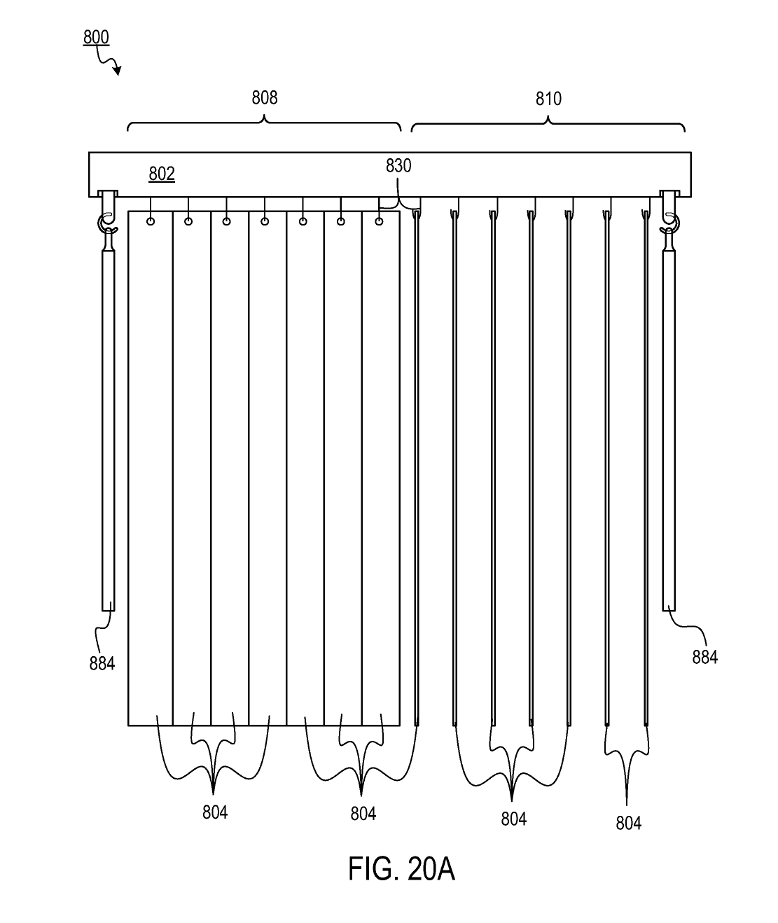

FIGS. 17 A-D depict a cordless multi-partition blind system 500. The cordless multi-partition blind system 500 includes a cordless mechanism that lifts and lowers blinds without the need to pull or release lift cords. Any of the embodiments of the present disclosure may incorporate some or all of the features of the cordless mechanism to lift and lower blinds. Similarly, while not shown in FIGS. 17A-D, the cordless multi-partition blind system 500 may incorporate some or all of the features of other embodiments of the present disclosure to control the opening and closing of individual partitions of slats.

FIG. 17A illustrates a front view of the cordless multi-partition blind system 500 having a first partition 502, a top partition rail 504, a second partition 504 and a midrail 508. In various embodiments, the first partition 502 includes a first ladder 510, first cords 512, first spool fixtures 514a, 514b, a first coil 516, a first spring force balance 518, a first U-shaped pulley 550, and a first V-shaped pulley 552. Similarly, the second partition may include a second ladder 510, second cords 512, second spool fixtures 514a, 514b, a second coil 516, a second spring force balance 518, a second U-shaped pulley 550, and a second V-shaped pulley 552. The combination of the first spool fixtures 514a, 514b and the first spring force balance 518 create a counterbalance that causes the slats of the blinds to remain in place after appropriate force is applied to lift, lower, and tilt the slats to an open, closed, or an intermediate position. Likewise, the combination of the second spool fixtures 524a, 524b and the second spring force balance 518 counterbalance the weight of the slats in the second partition 506. As such, if a user applies force to raise or lower a bottom slat of the second partition 506, the second partition 506 will remain in place after the user releases the bottom slat. FIG. 17B depicts an enlarged view of the cordless mechanism for the top partition 502.

Referring back to FIG. 17A, the cordless multi-partition blind system 500 may further include third cords 532 that are coupled to the midrail 508 at a first end. Proximate to the second end of the third cords 532, the third cords 532 are coupled to third spool fixtures 534a, 534b. The third spool fixtures 534a, 534b are then coupled to a third spring force balance 538 via coil 536. The third spring force balance 538 provides a counterbalance for all lower partitions, as will be described in greater detail below.

In various embodiments, the spring force balance 518, 528, 538 comprise an internal torsional spring, a coil, and a spool. The internal torsional spring retains mechanical energy in response to the coil unwrapping and applying a force onto the internal torsional spring. The internal torsional spring then applies a constant force onto the coil, which may be used to counterbalance the weight of the partitions 502, 506 or the midrail 508. It is to be understood that any suitable constant force balance system may be used for the spring force balance 518, 528, 538.

FIG. 17C shows an exemplary spool fixture 540 that may be used for spool fixtures 514a, 514b, 524a, 524b, 534a or 534b. In some embodiments, the spool fixture 540 has a top spool 542, a bottom spool 544 and a spur gear 546 on a midsection of the spool fixture 540. The top spool 542 has a slot where the coil (e.g. coil 516, 526 or 536) is attached and wound around the top spool 542. The bottom spool 544 has a catching slot where cord or string (e.g. cords 512, 522, or 532) is attached and allows such cord or string to be anchored and wrap and unwrap around the bottom spool 544. The spur gear 546 on the midsection has a number of teeth such that when the two equal spool fixtures are paired together, the pair of fixtures will allow the cord or string to spool or unspool at the same time the coil contracts and releases without the coil becoming completely coiled or uncoiled. The top spool 542 has a diameter that maximizes the spooling of the coil so that an optimal amount of coil is used relative to the weight of the blinds. It is to be understood that, as shown in FIGS. 17A-B, the coil may be coiled around a single fixture of the pair of fixtures. Each pair of fixtures share a coil and contributes to supporting a portion of the total weight of the blinds. The number of paired fixtures is sufficient to counterbalance the total weight of the blinds so that when adequate force is applied to the partition end rail of a partition, the blinds will move upward or downward and tilt forward or backward and remain at the point where and when said force is stopped or eliminated. The coil is of a size and strength that accounts for the weight of the blinds in a partition and the distance the blinds must travel to move upwardly until all slats are gathered at the top partition rail 504 or downwardly until all slats in the partition are fully extended.

The string or cord is either wound or unwound when adequate force is applied to the partition end rail causing the slats in the partition to move upwardly or downwardly. The string is spooled by the coils so that adequate tension always exists between the spooled end of the string and the partition end rail.

FIG. 17D shows an exemplary double pulley 560 having a U-shaped pulley 562 and a V-shaped pulley 564. In between the spooled end of the string at the spool fixtures (e.g. 514a, 514b, 524a, 524b, 534a, or 534b) and the partition end rail, the cords (e.g. 512, 522, 532) pass snugly around the u-shaped pulley 562 of the double pulley 560 and then downward through guide holes in the partition rail (e.g. the top partition rail 504 or the midrail 508) and typically through centered holes in each partition slat and maintain a perpendicular position to the floor and onward to the partition end rail in which the cord terminates and is attached to the partition end rail. The tension allows the fully lifting and the fully lowering movement of the slats in a partition and for the slats to be counterbalanced at any point in between being fully lifted or fully extended. It is to be understood that the U-shaped pulley 562 and the V-shaped pulley 564 may be representative of the first and second U-shaped pulley 550, 554 and the first and second V-shaped pulley 552, 556 respectively.

The V-shaped pulley 564 of the double pulley 560 supports a ladder (e.g. one of ladders 510, 520). The ladder having the slats of the respective partition represents a portion of the weight that is being counterbalanced by the pair of spool fixtures and includes in the tensioning of the spooled cord consideration of the resistance, which allows forward and backward tilting movement of the slats. The strings of the ladder pass through guide hole(s) and are coupled to the V-shaped pulley 564, such that in response to adequate force being applied to the partition end rail causing a lifting or lowering movement of the slats in the partition, the ladder attached to the V-shaped pulley 564 will catch momentarily which cause the rotational tilting forward or backward of the slats. After allowing each ladder in a partition's slats to tilt forward or backward to the maximum rotational movement possible, the V-shaped pulley 546 continues turning as long as adequate force is applied, but the ladders remains stationary. As shown in FIG. 17A, the top partition rail 504 has at least one additional set of paired spool fixtures 534a, 534b that counterbalance the weight of all lower partitions. The coil tension of the paired spool fixtures 534a, 534b will typically be greater than the other paired fixtures in the top partition rail 504 if there are more than two partitions present.

In various embodiments, a midrail is present for each partition that exists below the top partition rail 504. The cordless multi-partition blind system 500 may have one or more midrails 508. The midrail 508 has the same parts as those that have been described in the top partition rail 504. Likewise, each midrail 508 present will have additional support paired spool fixtures which counterbalance the weight of all partitions below. The support paired spool fixtures will have greater tension than the given paired spool fixtures of the midrail in which there are more than one lower partition counting from the currently described midrail. There are numerous methods to cause the midrail to stabilize, such as by employing a spring-loaded housing with rubberized fixture ends and using a combination of gears to create a point at which force will be applied to move said fixtures inwardly or outwardly. It is to be understood that the same method from other embodiments described in detail may be used, such as using a shaft with threaded ends, the outwardly rectangular shaped nut, the slightly larger rectangular shaped housing, and special shaped ends with rubber or thick foam fixtures on end. As is also the case in previously described embodiments, the dimensions are altered to fit the need relative to the size of the midrail and the architectural opening. The movement of the fixtures, similarly, is outward to create pressure against the vertical side wall or edge of an architectural opening so that the midrail is stationary and stable at a desired location. The movement is inward to release the pressure and allow the midrail to hang in suspension from its support cords.

In some embodiments, the midrail is supported by the support paired fixtures in the top partition rail 504. The support paired fixtures in the top partition rail 504 are sufficient in number to counterbalance all respective lower partitions. As depicted in FIG. 17A, there is one second partition 506 lower than the first partition 504 that includes the midrail 508. The spooled cord or string 532 of each paired spool fixture 534a, 534b passes through guide holes in the top partition rail 504 and then through holes in the top partition slats. The cord or string 532 continues onward through the end rail of the top partition and downward to a support attachment 570 on the midrail 508 that is triangular in shape and allows the distance between all slats when they are in an open position to appear to have the same distance between the slats and the midrail 508 and the look of the same distance in between the slats of all partitions. The support attachment 570 may be in some other shape that will create stability for the midrail 508 as it hangs freely without the use of the fixtures that create tension with the sides of the architectural opening. The support attachment 570 may be support cords that pass along the front and back outer edges of the slats and connect to the top partition rail 504. Each subsequent midrail that exists will connect to the midrail above it in the same manner as the first midrail connects to and is supported by the top partition rail.

Furthermore, the top partition rail is installed into an architectural opening by using support brackets 580. The support brackets 580 are used at each end of the top partition rail 504. In some embodiments, the support brackets 580 are rectangular in shape and closed on wall side and open on the inside (wall side and inside are relative to the architectural opening). The front side of the support bracket 580 has a latch which swivels upwardly into an open position and downwardly into a closed position. Middle top partition rail supports may be used for additional support of the top partition rail 504. In certain embodiments, middle top partition rail supports are u-shaped and open on both sides relative to the side walls of the architectural opening and has a latch which swivels upwardly into an open position and downwardly into a closed position.

The support bracket 580 on each end has holes in the closed side or the wall side of the bracket. Screws, nails, or the like are used to secure the brackets to the architectural opening. The middle top partition rail support has holes on the top side. Screws, nails, or the like are used to secure the middle top partition support to the architectural opening. Each latch is swiveled upwardly to an open position to allow the top partition rail to fit inside the support brackets. Once the top partition rail 504 is inside and resting upon the top partition support brackets 580, the latches are swiveled downwardly to a close position. The latches lock into place with a shape on the latch which enters an indentation in the body of the support bracket 580.

Operationally, with an exemplary cordless multi-partition blind system 500 having the first and the second partition 502, 506, if both partitions 502, 506 are initially fully gathered toward the top partition rail 504, adequate force is applied to the lower partition's end rail that causes the second partition 506 to become fully extended. The force is continuously applied until the midrail 508 reaches the desired point relative to the architectural opening. Force is applied to the handle on the midrail 508 so that the end fixtures move outwardly and create enough pressure against the architectural opening so that the midrail becomes horizontally stable (as previously described and shown in FIGS. 13-16). The slats in the first partition 502 are fully extended by applying force to the top partition end rail. The force is a downward pulling in a manual situation. The slats are either fully extended downward to the midrail 508 or to some desired point prior to the slats being fully extended. When the slats are fully extended, the top partition end rail may be attached to top hooks on the midrail 508. As force is applied to the partition end rail in the first partition 502 causing an upward lifting, the slats tilt rotatingly from a fully upward position to a fully downward position. The force is withdrawn at any point in between to leave the slats tilted in a desired position between completely closed or completely open. As force is applied to the top partition slats causing a downward lowering, the slats tilt from a fully downward position to a fully upward position. The force is withdrawn at any point in between to leave the slats tilted in a desired position between completely closed or completely open. The slats may be oriented to move rotatingly in the opposite direction as adequate force is applied.

While the midrail 508 is in a stable horizontal position, force is applied, manually in this example, to the partition end rail of the second partition 506 causing the slats in the second partition 506 to gather upwards toward the midrail or to fully extend downward, or until a desired point is reached in either direction and force is withdrawn. In the two partition example, the partition end rail of the second partition 506 hangs freely until it is extended to rest on the bottom of the architectural opening. For multiple partitions, the lower partition's partition end rail may be attached to the hooks on the next lower partition midrail. For all slats employed with lower partition midrails, as force is applied to the lower partition end rails causing an upward lifting, the slats tilt from a fully upward position to a fully downward position. The force is withdrawn at any point in between to leave the slats tilted in a desired position between completely closed or completely open. As force is applied to the top partition slats causing a downward lowering, the slats tilt from a fully downward position to a fully upward position. The force is withdrawn at any point in between to leave the slats tilted in a desired position between completely closed or completely open. Slats may be oriented to move rotatingly in the opposite directions as adequate force is applied.

The slats in any partition may be lifted or lowered independently from slats in another partition. When the partition's midrail in a stable position applying adequate force to the partition end rail will cause the coil to upwardly or downwardly counterbalance the weight of the partition end rail and slats in the partition and the spur gears to turn, spool the cord or string, and maintain adequate tension as the partition end rail and slats move upwardly or downwardly.

To lift and gather the partitions toward the top partition rail 504, the user may first apply adequate force causing the lifting of the partition end rail and the slats in the first partition 502 so that the slats of the first partition 502 are gathered upwardly at the top partition rail 504. Adequate force is then applied to the handle on the midrail(s) thereby causing the end fixtures to release the tension held against the sides of the architectural opening (as previously shown and described in FIGS. 13-16). Adequate force is applied in an upwardly manner to the partition end rail of the second partition 506 so that the partition end rail and slats of the second partition 506 gather toward the top of the partition's midrail 508. Force is again or continuously applied at the same point causing the partition end rail, the slats in the partition 506, and the partition's midrail 508 to move upwardly. The coils in the support paired spool fixtures 534a, 534b in the top partition rail 504 counterbalance the weight of the partition end rail, the slats in the second partition 506, and the partition's midrail 508. The counterbalancing via the spring force balance 538 causes the spur gears to turn and the support strings 532 attached to the midrail 508 to spool and upwardly wind the partition end rail, the slats in the second partition 506, and the midrail 508 toward the top partition rail 504. As the support strings 532 are spooled, adequate tension between the coil and the weight of the midrail 508 is maintained. The adequate force is continuously applied until the midrail 508 moves upwardly and contacts the partition end rail in the first partition 502 and the slats and partition end rail of the second partition 506 are fully gathered toward the top partition rail 504.

In our example of this embodiment there are two partitions. In a method having more than two partitions, the top partition end rail is first lifted through the use of adequate force until the slats in the uppermost partition are fully gathered at the top partition rail 504. The partition end rail in each of the lower partitions may be lifted toward each respective midrail. All midrails are then positioned to hang freely. Adequate force is then applied to the partition end rail in the lowest partition until all partition end rails, slats, and midrails are gathered upwardly toward the top partition rail 504.

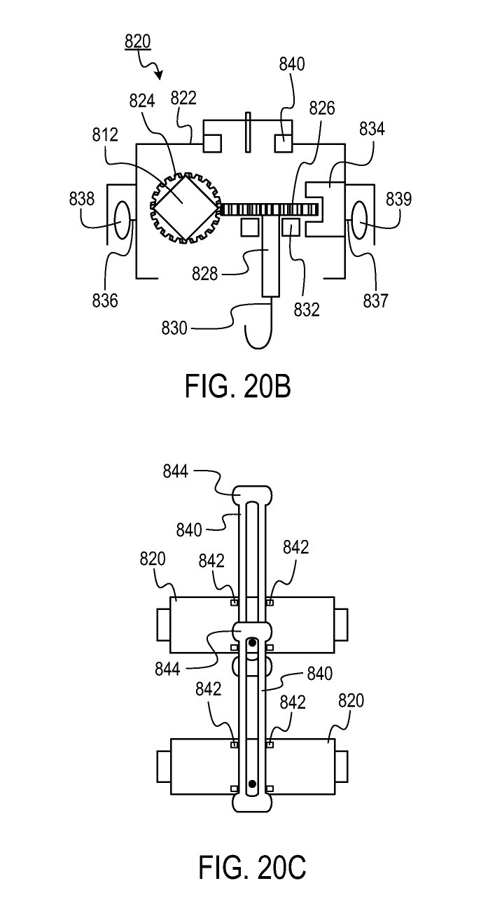

FIGS. 18A-18D depict an exemplary embodiment of an automatic multi-partition blind system 600 for individual slat control. FIG. 18A illustrates a front view of the automatic multi-partition blind system 600. In one or more embodiments of the present disclosure, the automatic multi-partition blind system 600 includes a top partition rail 610, a first side rail 620, a second side rail 660, a plurality of slats 670, lift cords 680, and indicators 690. The side rails 620, 660 may be used to create multiple partitions to control the amount and positions of light flow. Side rails 620, 660 may have a rectangular u-shaped appearance and may be attached to the sides of an architectural opening. In some embodiments, each side rail 620, 660 has a side door that is openable or removable so that access may be gained to an interior cavity of each side rail 620, 660. The side rails 620, 660 are disposed on either the left or right facing of an architectural opening. While the first side rail 620 is depicted as primarily controlling the engagement and rotation of the slats 670, either side rail 620, 660, or both, may be employed as primary or secondary controlling over the individual slats 670.

FIG. 18B depicts a left side view of the first side rail 620 having a plurality of slat control fixtures 630. FIG. 18C shows a front view of a single slat control fixture 630. In one or more embodiments, slat control fixtures 630 include a clamp 632, a rack gear 640, a first servo motor 642 coupled to a first gear 644, and a second servo motor 646, and a third servo motor 650. The clamp 632 has a first jaw portion 634, a second jaw portion 636, and a threaded shaft 638.

In some embodiments, the clamp 632 moves with three degrees of freedom, actuated by the first servo motor 642, the second servo motor 646, and the third servo motor 652. The first servo motor 642 controls a linear degree of freedom of the clamp 632 along axis B. The first servo motor 642 rotates the first gear 644. The first gear 644 is coupled to the rack gear 640 such that, as the first gear 644 rotates, the rack gear 640 and the clamp 632 will translationally move along an axis B. The second servo motor 646 controls a degree of rotation of the threaded shaft 638. A threaded hole of the first jaw portion 634 receives a first portion 638a of the threaded shaft 638 and translationally moves along an axis C of the threaded shaft 638. A threaded hole of the second jaw portion 636 receives a second portion 638b of the threaded shaft 638 and translationally moves along the axis C. The first portion 638a and the second portion 638b are oppositely threaded such that, as the threaded shaft 638 rotates about axis C, the first jaw portion 634 and the second jaw portion 636 both move towards each other (i.e. towards axis B) or away from each other (i.e. away from axis B). Finally, the third servo motor 650 controls a degree of rotation of the clamp 632 about the axis B.

The slat control fixtures 630 allow a user to engage the desired slats 370 that will move rotatingly about to a fully opened position, a fully closed position, or some intermediary point on each rotational axis. The clamp 632 receives an end of an individual slat 670. In response to the clamp 623 rotating via the third servo motor 650, the individual slat 670 will rotate about the rotational axis B.

FIG. 18D illustrates a top view of the top partition rail 610 having microcontrollers 612, lift cord motors 614, a power source 616 and an aperture 618. In various embodiments, the microcontrollers 612 are coupled to the first, the second and the third servo motors 642, 648, and 650 respectively, as will be described in greater detail below. Lift cord motors 614 actuate to gather or release the lift cords 680 by the same length on either side of the slats 670 to facilitate the left and the right sides of the slats 670 lifting upwards or lowering downwards at a constant rate. The power source 616 supplies electrical current to the microprocessors 612, the lift cord motors 614, and the servo motors 642, 648, and 650. Furthermore, aperture 618 is disposed in a bottom wall of the top partition rail 610 and receives cords coupling the microprocessors 612 to the servo motors 642, 648, and 650.

In some embodiments, a programmable method controls each individual slat 670. Each slat 670 may be assigned a number or letter or some other suitable designation the user may choose through programming functions. At least one of the first and second side rails 620, 660 may have a discrete visual representation 690 of the corresponding slat 670 to indicate whether the corresponding slat 670 is engaged or disengaged to the corresponding slat control fixture 630. A rotational position of each slat 670 may be stored in memory. The rotational position may be tracked in the form of degrees or some other suitable measurement that is descriptive of the position of the rotational movement about the axis for each slat 670.

Each slat 670 may be returned to an initial starting position. The repositioning of each individual slat 670 to an initial starting position may also be referred to as a reset mode or an original position of orientation, for example. In one or more embodiments, aligning marks are disposed on at least one of the first and the second side rails 610, 660 for each slat 670. The aligning marks may be read by a sensor disposed on the at least one first and second side rails 610, 660. In response to sensing, activating, reading, or some other form of recognition, the corresponding slat control fixture 630 aligns, realigns, or otherwise causes the slats to return to an original or initial state or position relative to a rotational axis. A stopper stem may be used on a bottom slat of the slats 670 that enhances the rotational opening and closing of the bottom slat.

The upward lifting of the blinds occurs by the user following similar steps as described in other embodiments of the present disclosure where lift cords are employed. The lifting and lowering of all slats 670 may also be programmable and motorized. Lift cords 680 may be anchored at the bottom partition rail or the bottom slat, for example. A combination of mechanisms, such as spools, pulleys, and the like, may work in conjunction with a lift cord motor 614 that causes the combination of mechanisms to move and either wind or unwind thereby causing the slats 670 to be lifted or lowered. In some embodiments, lift cords 680 pass through holes in the slats and anchor at the bottom partition rail or bottom slat. The lift cords 680 are pulled upwardly by the lift cord motors 614 that turns a spool that winds and collects the lift cords 680 as the slats 670 move upwardly and releases the lift cords 680 as the slats move downwardly. Various types of materials may be used in this embodiment, such as metals, plastics, and other appropriate substances. It is to be understood that a cordless mechanism or any other suitable method for lifting and lowering the slats may be used.

Any suitable method to programming or writing code and various coding languages, and platforms may be used to encode or otherwise program the present embodiments of the present disclosure so that the user can individually select slats to create partitions and control the rotational movement of the slats in the respective partitions. The method may use remote control devices and various forms of power and include any number of timing features. Slats may also be supported by altering the form of the ladder system and avoiding the use of a side rail. Furthermore, both the side rail and an altered ladder system may also be used in conjunction with one another to accomplish control over each individual slat. All programmed controls, including wireless and remote access through internet protocols and gateways may be used in this embodiment and in other embodiments of the present disclosure.

Operationally, the user may select, through a remote control device or a control device located on one of the partition or side rails, a number of slats to be opened or closed rotatingly about a respective axis of each slat. The slats selected by the user may be indicated on a side rail where the visual representation 690 illuminates demonstrating a specific slat has been chosen and allowing the user to have a visual of which slats will be engaged to move rotatingly to a fully open, fully closed position, or some intermediary position about the respective axis. Each slat may be selected independently of all other slats. The user may then select a predetermined rotational position for the slats on the respective axis of each slat. The user, via the remote control device or a control device located on one of the partition or side rails, then activates the rotational movement of the slats to the desired position.

Alternatively, in other embodiments, once the user has selected the slats to be moved rotatingly, the user, via a remote control or a control device located on one of the top partition rail 610 or side rails 620, 660, controls the rotational movement of the selected slats such that the slats stop at a desired position. At a time the user chooses to lift or lower the slats, the microcontrollers 612 send a signal to the slat control fixtures 630 to return the slats to the original position, reset mode, or position of orientation. Each slat control fixture 630 disengage with the corresponding slat and rests in a position that allows upward and downward movement of slats 670 collectively. The user makes the choice to lift or lower the slats through the use of a remote control device or a control device located on the top partition rail 610 or side rails 620, 660.

The remote control device and the control device on the top partition rail 610 or side rails 620, 660 described in this embodiment may be controlled by a software application through a Wi-Fi network and through internet gateways. Numerous other combinations of software control, remote control devices, Wi-Fi network, Bluetooth, and the like, may be used to effectively control the movement of each slat in either horizontal or vertical blinds. Other mechanisms and methods may be used to isolate and control each slat that will ultimately result in the creation of partitions in blinds with slats. The present embodiment is only one example of how each slat may be individually and independently controlled.

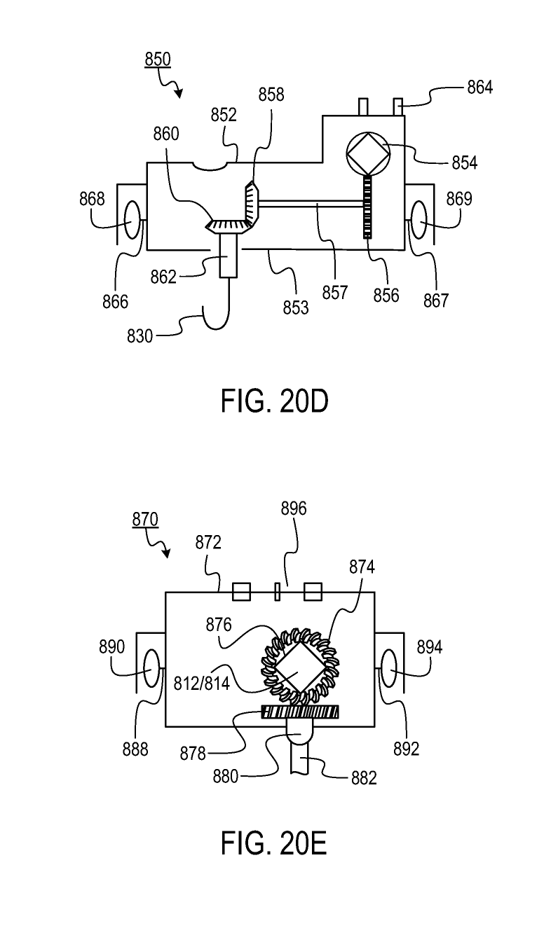

FIGS. 19A-C depict an exemplary multi-partition blind system 700 for manual individual slat control that comprises a top partition rail 702, a first side partition rail 704, a second side partition rail 706, and a partition end rail 708. The top partition rail 702 may house spools 714 that collect lift cords 712 that are ample in number to create balance and ease of lifting of all slats 710 present from the partition end rail 708 toward the top partition rail 702 and downward to a fully extended position. The spools 714 may be driven through the use of gears (for example, spool fixture 540 as shown and described in FIG. 17C) which may create an advantage in such a manner the user will not bear the total weight of the lifting of the blinds and will not be overwhelmed by the lowering of the blinds. As previously described, the spools 714 may further collect or release a counterbalancing cord 716. The cord or counterbalancing cords 716 may run through a passage outward and inward through the top partition rail 702. As the cord(s) 716 may run outside the top partition rail 702, in some embodiments a pulley(s) 718 allow(s) the cord 716 to turn downward and perpendicular to a level floor.

In some embodiments, the cord 716 may have enough length to reach a crank 726 or some other suitable device that would allow a user to control the upward and downward movement of the cord 716. The pulley(s), cord(s), crank, or other controlling device(s) 726 are all enclosed in a housing that may be rectangular is shape, may be stiff and/or sturdy enough to remain in position while in use and may be either attached to the first side partition rail 704 or to the side of an architectural opening. The crank 726 may also be housed inside or made a part of the first side partition rail 704. A weight, resistance coil 722, or the like may be attached to the cord 716 that acts to counterbalance the weight of the blinds or slats 710 so that as the crank or control device 726 turns and causes either the lifting or lowering of the slats 710 collectively, the slats 710 remain in place when the user stops use of the crank or control device 726. The crank or control device 726 may turn a gear that has an attached pulley that allows the cord 716 and counterbalance weight 722 to travel upward and downward and may create enough travel distance in the cord 716 to allow the slats 710 to be fully extended or to be fully gathered toward the top partition rail. The gears, pulleys, crank, and control devices described here may be made from materials such as plastic, metal, wood, or the like. The cord 716 may be nylon or of some other durable and appropriate material.

In various embodiments, an appropriate number of ladders (not shown) made from appropriate substance such as string, cloth, or the like support the slats 710. The appropriate number of ladders is relative to the width of slats 710 and will aid the slats 710 from bending or sagging toward the middle portion of the slats 710. The ladders may terminate inside the top partition rail 702 in a manner that may allow the ladders to remain as support for the slats 710.

In some embodiments, the first and second side partition rails 704, 706 are rectangular in shape and sufficiently sturdy so that the first and second side partition rails 704, 706 connect with and form a frame that allows the slats 710 to be operated either rotatingly opened or closed or fully lifted or fully extended. The side partition rails 704, 706 may also be attached to the sides of an architectural opening. At least two guide tracks 740, 750 may be disposed in either one of the side partition rails 704, 706. As shown in FIG. 19A, a first and a second guide track 740, 750 are disposed in the second side partition rail 706. The guide tracks 740, 750 may be fully enclosed with a hollow inside that allows either a first and a second wheel 742, 752 respectively to roll upward and downward by use of a respective first and second crank 746, 756 or other control device which moves a cord or multiple cords, which may be made of nylon or some other appropriate material. The cord or cords may travel around a respective first and second pulley 744, 754 located in the upper portion of each guide track 740, 750. A wheel or multiple wheels 742, 752 attached to the cords or strings may pass around each respective pulley 744, 754 in a continuous motion. At least one of the guide tracks 740, 750 may be sufficiently large or otherwise structured so that more than one wheel 742, 752 may roll upward and downward through the guide track 740, 750. The first guide track 740 may be used to engage individual slats 710 that will be moved rotatingly to an open or closed position or some intermediary position.

The second guide track 750 may be offset and perpendicular to the first guide track 740 or otherwise appropriately aligned. For each wheel 742, 752, a crank or control device 746, 756 may turn a gear that has a pulley 746, 756 that causes a string or cord, made of either nylon or other appropriate material, to move as force is applied to the crank or control device 746, 756. The wheels 742, 752 may be attached to the string or cord in such a manner that allows the wheels 742, 752 to move upward or downward, depending on the force applied to the crank or control device 746, 756.

As shown in FIGS. 19B-C, a spring loaded moveable pin 760 may be attached to a first end 710a of each slat 710. Spring loaded pin 760 may have a rounded head 762 and an internal spring 766 that allows entry into a hole and then locks into place onto one of the guide tracks 740. As the first wheel 742 is moved upward or downward by applying force to the crank or control device 746, the wheel 742 rolls over the rounded head 762 of the spring loaded pin 760 and causes the pin 760 to push horizontally against the attached slat 710. A second end 710b of the slat 710 is received by a ladder system 730 and lock into place. To disengage or unlock the slat 710, the second wheel 752 in the second guide track 750 is moved upward or downward by applying force to the crank or control device 756. As the second wheel 752 in the second guide track 750 moves upward or downward, the second wheel 752 rolls over the rounded head 762 that covers the internal spring 766 of the pin 760 and disengages or unlocks the pin 760 causing the relative slat 710 to move to a non-engaging position (i.e. the slat 710 disengages from the ladder system 730 and will not be able to move rotatingly). In certain embodiments, the multi-partition blind system 700 includes a visual indicator showing which slats 710 are engaged, such as a protruding attachment to a wheel, solar or battery powered led lights, or some other suitable method.

The first side partition rail 704 may house a sturdy control ladder system 730 that may be made of metal, steel, sturdy plastic, strings, a combination of such materials, or some other material that has the capacity to move the entire length of a slat 710 rotatingly to a fully opened, fully closed, or intermediate position. A crank, lever, or other control device 734 may be used to apply force that will cause the control ladder system 730 to move and in turn move the slats 710 rotatingly to an open, closed, or intermediary position. A gear and/or connective mechanisms, such as pulley 732, may be used with the crank or other control device 734 to cause the control ladder system 730 to move. In response to the first wheel 742 on the second side partition rail 706 rolls and engages a slat 710, the slat 710 will move into the ladder system 730 and remain there until slat 710 is disengaged. The spring loaded pin 760 may allow slats 710 to move rotatingly about an axis to a fully opened, fully closed, or intermediary position.

Operationally, a user applies force to a first crank 746 on the second side partition rail 706 to select the slats 710 which will be moved rotatingly. In one or more embodiments, the first guide track 740 comprises more than one first wheel 742 such that the user has more choices in how the slats 710 will be partitioned. There can be as many wheels and cranks as is practical under the circumstance. As the first crank or control device 746 receives appropriate force, the first wheel 742 rolls upward or downward. As the first wheel 742 rolls upward or downward, the first wheel 742 passes over the spring loaded pins 760 of each slat 710. For each slat 710 the first wheel 742 passes over, the first wheel 742 pushes the spring loaded pin 760 into a locked position. Pins 760 may have a sensor that may trigger the visual indicator that indicates that the respective slat 710 has been chosen (if engaged illuminated, dark if not chosen, for example). When the spring loaded pin 760 is in a locked or engaged position, the respective slat 710 is moved horizontally into the ladder system 730 in the first side partition rail 704. When the user has applied appropriate force to move all desired slats 710 into the ladder system 730 in the first side partition rail 704, the user may terminate the force. The user then applies an appropriate force to the crank or control device 734 on the first side partition rail 704 to cause the control ladder system 730 to move the engaged slats 710 rotatingly to an opened, closed, or intermediary position.

In various embodiments, to lift or lower the system of slats 710, or the blinds, the user disengages all slats 710 from the ladder system 730 by applying appropriate force to the second crank or control device 756 that causes the second wheel 752 to roll over the round head 762 of the internal spring 766 of the pin 760. After all slats 710 are disengaged from the ladder system 730, the user applies adequate force to the crank or control device 726 that causes the slats 710 to be lifted toward the top partition rail 702 or lowered to a fully extended position.

Motors, processors, remote control devices, timers, and the like may be used in the multi-partition blind system 700, like other embodiments, that will cause the cranks to turn, for example, and select slats to be moved rotatingly about an axis.

This example of an embodiment begins to demonstrate how various features of the system described herein for partitioning blinds with slats may be combined. There are numerous embodiments and many combinations of embodiments that may be used in conjunction with one another which will result in the partitioning of blinds with slats in such a manner at to create some degree of independent movement of groups of slats to the point of choosing individual slats.

In each embodiment of the present disclosure, there are various methods whereby the width of the top partition rail, the width of the slats, and the widths of the end or bottom partition rails may be adjusted to fit the size of an architectural opening. In certain instances, the side partition rails may be adjusted so that the blinds will fit an architectural opening. For example, in some embodiments, the width of the blinds may be adjusted to a shorter size by cutting length from the top partition rail, the bottom or end partition rail and the slats that are beyond the points where the operational mechanisms are located. Length that may be cut to size may range in any appropriate distance so that blinds may be manufactured in sizes that allow custom width fittings of architectural openings to range from the smallest desirable size to the largest desirable size. In other embodiments, the slats may be manufactured so that one end of the slat is slighter larger than the other and thereby allows the smaller end to slide inside of the larger end. Certain embodiments include a mechanism, such as a small clear clamp, on each slat that secures the position and desired length of each slat. There may be marks on the slats, either the larger or the smaller or both, that provide a method for ensuring that each slat will be adjusted to the same length.

In one or more embodiments, the top partition rail, side partition rail(s), and the end or bottom partition rail are manufactured to adjust in size by a similar type sliding method. The partition rails may be manufactured each in two parts. For example, the top partition rail may operationally function as one part, but may adjust in length by having a slightly larger side. The smaller side may slide through the inside of the larger side. There may be a guide(s) present with tracks that accommodate or facilitate a sliding movement of the two sides of the partition rail. There may be a stopper or some other anchoring mechanism that holds the two sides of the partition rail in a desired place. There may be markings to indicate relative position so that the top partition rail may be adjusted to the same length as the bottom or end partition rail. In instances where there are side partition rails, those rails may be adjusted to the same size.

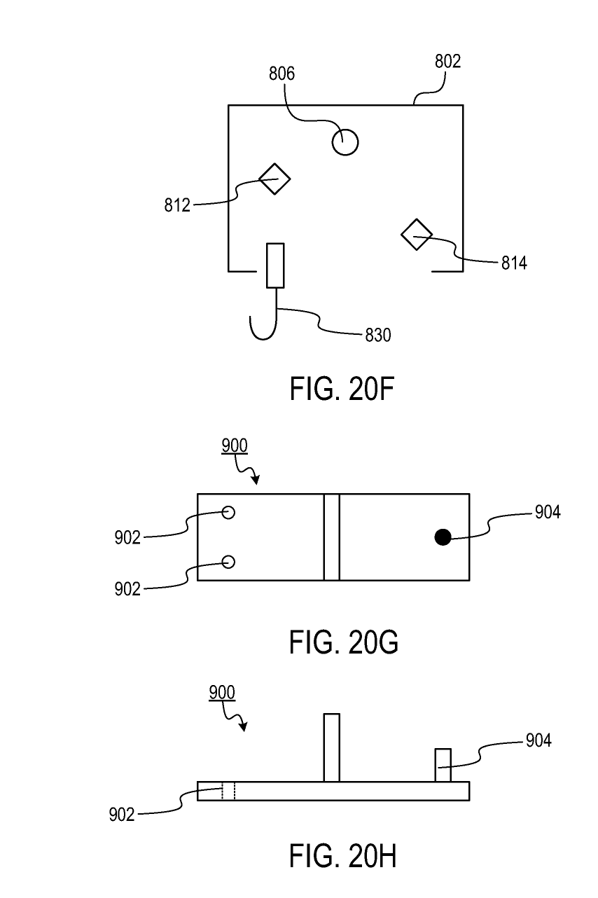

FIGS. 20A-H illustrate a multi-partition blind system 800 having slats 804 in a vertical orientation. In some embodiments, the multi-partition blind system 800 has a top partition rail 802 and a first and a second partition 808, 810 having slats 804. As will be shown and described in FIGS. 20B-H, the first partition 808 has a first guide shaft 812, a set of first fixtures 820, a plurality of tie links 840 and a driver fixture 870 coupled to a wand 884. Similarly, the second partition 810 has a second guide shaft 814, a set of second fixtures 850, a plurality of tie links 840 and a separate driver fixture 870 coupled to a separate wand 884. It is to be understood that, while two partitions 808, 810 are shown, any number of partitions may be used with the present disclosure.

In various embodiments, the multi-partition blind system 800 comprises a rectangular u-shaped top rail 802 which has an opening on the downward facing side. A top shaft 806 (as shown in FIG. 20F) with a cylindrical shape, or some other suitable shape, transverses a longitudinal distance of the top rail 802 proximate to a top of the top partition rail 802. The top shaft 806 is supported by and held firmly in place by brackets which are positioned at each end of the top partition rail 802. The brackets fit into the hollow opening of the ends of the top rail 802 and are shaped to conform to the top rail openings on each end. The brackets are held in place with screws that tighten a bar which is positioned perpendicular to the downward opening of the top partition rail. The screws pass through holes in the bars and screw into the receiving end which is passed the bottom opening of the top rail 802 and is a part of the bracket. Tightening the screws creates pressure and stabilizes the brackets in place.

The top shaft 806 is stiff and supports weight from fixtures 820, 850 and slats 804 and serves as a connecting shaft that allows multiple partitions 808, 810 to slide almost entirely to one side or another. The brackets and shafts are made from any material that will cause the shaft to operationally support the weight of fixtures and slats, such as plastic, metal, wood, or the like. The slats 804 may be made from materials such as plastic, wood, fabrics, or any other material that is suitable to function as slats.

For each partition 808, 810, there are unique guide shafts 812, 814. Each unique guide shaft 812, 814 transverses the distance of the top rail 802, each along and parallel to the sides of the top rail 802 and lower in position relative to the top shaft 806, as shown in FIG. 20F. In some embodiments, the unique guide shafts 812, 814 are rectangular in shape, or some other suitable shape that is sufficient to cause ample friction which will allow movement when ample force is applied. The guide shafts 812, 814 fit into the brackets in a manner that allows the guide shafts 812, 814 to turn rotatingly. The guide shafts 812, 814 are sturdy and have strength enough to adequately support the fixtures 820, 850 and slats 804 and may be made of materials such as plastic, metal, wood, or the like.

In some embodiments, two methods for increasing the number of partitions beyond two are to widen the top partition rail 802 or to make the fixtures 820, 850, unique guide shafts 812, 814, and top shafts 806 smaller in size.

In one or more embodiments, there are several configurations for the employed fixtures 820, 850. In the instances where there are more than two partitions 808, 810, an extended arm which holds supports for each of the slats 804 will extend so as to horizontally align all slats 804. The fixtures, head rail, gears, and other parts of present disclosure may be made from plastic, metal, wood, other sturdy and suitable material, and the like as is necessary.

The first fixture 820 has a housing 822 that comprises a worm 824 and a worm gear 826. The worm gear 826 has a neck 828 that extends downward in relation to the top partition rail. The neck 828 passes through an opening in the housing and connects to a clip 830. The clip 830 has an extension that supports a vertical slat 804 with a slotted hole 805. The slat 804 rests on the extension and the clip 830 adequately clamps closed to keep the slat 804 in stable position. The worm gear 826, neck 828, and clip 830 may be formed into a single rotational element. In certain embodiments, the single rotational element is supported in the housing by a wall on a bottom portion of the housing, which rests on a support 832 in the housing. The support 832 may be approximately the size of the worm gear 826, having a hole sufficient in size to allow passage of the neck 828. A housing internal support side wall 834 is used on a first side of the worm gear 826. The worm 824 holds the worm gear 826 in place on a second, opposite side of worm gear 826 opposite of the internal support side wall 834. In some embodiments, the first fixtures are rectangular in shape and may be made of plastic or any other suitable material such as metal, wood, or the like.

Teeth of the worm 824 are coupled to the worm gear 826, such that in response to adequate rotational force applied to the worm 824, the worm gear 826 (including the neck 828 and clip 830) will turn rotatingly. In various embodiments, the worm 824 has a rectangular shape opening in a center, or some other suitable shape that conforms to the shape of the unique guide rails. The fit of the unique guide rails passing through the opening in the worm 824 is sufficiently snug so that rotational movement of the guide shaft will also turn the worm 824.

In one or more embodiments, on the rear surface of the housing 822 that runs parallel to and nearest the unique guide shaft there is a stem 836. The stem 836 supports a first wheel 838 which is kept in place on the stem 836 by a broadened end of the stem 836. The first wheel 838 snaps into place on the stem 836 and spins freely when friction is created and adequate force applied in a direction opposite the wheel 838. A second wheel 839 is attached to an appendage 837 to the housing 822 on a side opposite from the first wheel 838. The appendage 837 extends from the housing 822 and toward the back side of the top partition rail 802 without interfering with any of the unique guide shafts 812, 814. The second wheel 839 is attached in a similar manner as previously described for the first wheel 838, but on the opposite side with a broadened end stem of the appendage 837.

FIGS. 20B-C illustrate a tie link 840 coupled to a top of the fixture housing 822. The tie link 840 couples each fixture 820 to a different fixture (e.g. another first fixture 820, a second fixture 850, a driver fixture 870). In various embodiments, the tie link 840 is narrow in width and extends a distance proportional to the width of the slats 804 used. In the relationship between a length of the tie links 840 and the slats 804, the tie links 840 and slats 804 are sized so that adjacent slats 804 have a slight overlap when the slats 804 are in a closed position.

In some embodiments, two short extensions 842 are disposed above the point where the tie link is attached to the fixture housing, which leaves a small space. The short extensions 842 allow enough clearance space for a second tie link 840 to fit and glide through the space. The short extensions 842 hold the second tie link 840 down and secured through means of an oversized head 844 on the unattached end of the tie link 840. The short extensions 842 allow the second tie link 840 to slide back and forth when adequate force is applied without the second tie link 840 working itself free. A distance a given partition covers depends on a number of fixtures and a length of each tie link. The fixtures 820 will expand in one direction and contract in the opposite direction.

FIG. 20D shows a second fixture 850 having a housing 852. In various embodiments, the second fixture housing 852 has an elongated appendage 853 which facilitates aligning the clips 830 from different partitions so that the slats 804 of each partition will align. That is, since the first guide shaft 812 is horizontally and vertically displaced from the second guide shaft 814, as shown in FIG. 20F, the second fixture 850 has to compensate for the displacement. For each additional partition, the elongated appendage 853 extends to similarly compensate such that the clips 830 in all partitions align.

In one or more embodiments, the second fixture housing 850 further comprises a worm 854, a worm gear 856, a first bevel gear 858, a second bevel gear 860, a neck 862 and a clip 830. The worm 854 that has a rectangular shaped hollowed center, or other suitable accommodating shape, that couples to the second guide shaft 814. When the second guide shaft 814 rotates, the worm 854 also consistently rotates. The worm 854 couples to the worm gear 856 having a shaft 857 which extends through the appendage 853. The first bevel gear 858 is disposed on an opposite end of the shaft 857 from the worm gear 856. The second bevel gear 860 is perpendicularly coupled to the first bevel gear 858, and is coupled to a clip 830 via a neck 862 that passes through an opening of the housing 852.

The housing 852 is built to support the combination of gears 854, 856, 858, 860 and the shaft 857 firmly in position such that when adequate force is applied at a force application point the gears 854, 856, 858, 860 and shaft 857 consistently turn and rotate accordingly in unison. It is to be understood that this is merely one example of a combination of gears and shafts that may be combined such that clips of different partitions align.

A top surface of the housing 852 is constructed so that two short extensions 864 opposite one another allow a tie link 840 to be snapped into position. The tie link 840 extends the same distance as the tie links 840 from other partitions. The appendage and back sides of the fixture housing have short stems 866, 867 with broadened ends. A free-spinning wheel 868, 869 snaps on over each stem 866, 867. The wheels 868, 869 may facilitate side-to-side movement of the fixture housing 852. In some embodiments a triangular shaped support is attached to the fixture housing and has a wheel. The height of the triangle shaped support with its wheel causes the fixture housing to hang from the top shaft and cause the clips to align in height and horizontally.

FIG. 20E illustrates a driver fixture 870 that facilitates driving a guide shaft of the unique guide shafts 812, 814. The driver fixture 870 has a housing 872 comprising an inward turned bevel gear 874 on its end and a hollow stem shaft center 876. The hollow stem shaft center 876 is shaped to snuggly accommodate a unique guide shaft (e.g. one of the unique guide shafts 812 or 814). In some embodiments, the hollow stem shaft center 876 is rectangular in shape, but any other suitable shape can be used. The first bevel gear 874 is positioned perpendicular relative to a second bevel gear 878. The second bevel gear 878 is attached to a neck 880 which passes through the driver fixture housing 872. The neck 880 is attached to a stem 882 having a hole distal to the neck 880. A wand 884 is coupled to the stem 882 via the hole. The driver fixture 870 may also be constructed to accommodate the use of a spool where string or cords may be used to apply force instead of a wand.

The driver fixture housing 872 has on its front side a stem 888 with a broadened top over which a first wheel 890 is snapped into place. An opposite side of the driver fixture housing 872 has an appendage 892 having a same length as appendage 837 of the first fixture housing 820 in the same partition. Similarly, a wheel 894 is coupled to the appendage 892. The wheels 890, 894 on the driver fixture housing 872 spin freely when adequate friction and force from contact is applied. A top of the driver fixture housing 872 has a slot 896 on one side to accommodate the oversized head portion 844 of a tie link 840. The opposite side has a slot which accommodates the thickness and width of the tie link 840.

Each unique partition has a driver fixture 870. In various embodiments, each successive partition beyond the first partition will have a different length appendage, which may increase in length. In some embodiments, the size of the top partition rail 802 from front to back, relative to an architectural opening, may need to be increased to accommodate all of the desired partitions. Slats 804 of the desired length and width are attached to the clips 830. The clips 830 clamp down and create adequate force and pressure against slats 804 to hold them in place.

FIGS. 20G-H depict an exemplary partition appendage connector 900. Each fixture housing 822, 852 has at a top thereof a portion where the partition appendage connector 900 is snapped into place. The top of each fixture housing 822, 852 is manufactured so that any of the fixture housings other than a driver fixture housing 872 may accommodate a partition appendage connector 900. In certain embodiments, the partition appendage connector 900 is a straight rigid stem that extends perpendicular to the guide shafts 812, 814 to a distance which presents a connection point 902 for the next partition appendage connector 900 of the adjacent partition. The connection point 902 may be a sturdy and stiff slot which allows a tie link portion 904 of a second partition appendage connector 900 to slide through the same distance as the tie links 840 which connect all other fixture housings. The second partition appendage connector 900 has a tie link which extends from its base the same distance as all the tie links 840 that connect the fixture housings in each respective partition. Each partition is connected by using partition appendage connectors 900 to create a connection between partitions.

In various embodiments, the top partition rail 802 is supported at the architectural opening with support brackets. At least one support bracket may be disposed at each end of the top partition rail 800. More support brackets may be used to support the middle section or other sections of the top partition rail 802, depending on the distance the top partition rail 802 travels across an architectural opening. The length of the tie links 840 is proportionally related to the width of the slats 804. For example, the longer the tie links 840, the wider the slats 804 can be. The slats 804 slightly overlap one another when the blinds are in a closed position so that maximum light is blocked out and the most privacy achieved. One vertically oriented slat 804 is inserted into each clip 830. The clips 830 keep the vertical slats 804 held in place. Inside the top partition rail 802, one partition is comprised of fixture housings 820, 850 that are coupled to the respective unique guide rail 812, 814. In an example where there are two partitions, there are two guide shafts 812, 814. Each guide shaft 812, 814 has a set of fixture housings 822, 852 and a wand 884 attached to the end of each driver fixture 870.

To fully extend the slats 804, whether the slats 804 are in an open, closed, or some intermediate position, force is applied to a force application point, which is achieved by pulling the inside wand 884 and causing the fixtures 820, 850 in the same partition to move horizontally along the respective guide shaft 812, 814. At the point where the first partition is extended sufficiently, the partition appendage connector 900 coupled with the next partition will cause the second partition to begin extending. The user continues applying adequate force in pulling the wand 884 until each tie link 840 in both partitions is fully extended. As each fixture 820, 850 moves outwardly and horizontally, the fixtures 820, 850 extend away from one another by approximately the distance between where the enlarged head 844 on the tie link 840 latches on to the short extensions 842, 864 on one fixture housing 822, 852 to the point where the tie link 840 is attached to the next fixture housing 820, 850. The method is similar if the vertical slats 804 are first gathered at the opposite end of the architectural opening. Conversely, the slats 804 may be initially gathered at the opposite end of the architectural opening. When adequate force is applied to the inside wand 884 (relative to the edge of the architectural opening), the fixtures 820, 850 expand to the distance of the tie links 840. The second partition extends fully due to the partition appendage connectors 900.

From the fully extended position of the slats 804, in one or more embodiments the slats 804 are retracted and gathered to one side or another by applying an adequate force to either wand 884 and thereby pulling wand 884 horizontally and causing the fixtures 820, 850 to be drawn to contact each adjacent fixture 820, 850 while the tie links 840 move upward and angled so that each tie link 840 is staggered and clear of one another.

As an example of slat 804 rotational movement, while the slats 804 of a partition are in a fully extended position, the slats 804 are moved rotatingly from an open to a close position, or vice versa, by applying a rotating force to the wand 884 of the subject partition. As the wand 884 turns rotatingly, it causes the stem to turn rotatingly. As the stem turns rotatingly, the guide shaft 812, 814 that passes through the center of the gear 874 in the driver fixture housing 872 turns rotatingly. As the guide shaft 812, 814 turns rotatingly, each respective fixture 820, 850 the respective guide shaft 812, 814 passes through will set the sequence of gears in motion which causes the clips 830 to rotate about. As the clips 830 rotate about, the slats 804 will move rotatingly. When the slats 804 slightly overlap with one another, the application of force may be withdrawn. At this point, the slats 804 are either forward facing or reverse side facing. It is to be understood that the force application point described in the present disclosure may be altered to accommodate forces driven by electricity, remote control, some combination of the two, or some other energy form, in addition to being of a manual nature.

What is claimed is:

1. A multi-partition blind system comprising:
a first partition of blinds comprising:
a first set of slats;
a first ladder system coupled to the first set of slats; and
a first slat control fixture coupled to the first ladder system to facilitate rotating the first set of slats; and
a second partition of blinds comprising:
a second set of slats;
a second ladder system coupled to the second set of slats; and
a second slat control fixture coupled to the second ladder system to facilitate rotating the second set of slats, the second set of slats rotating independently of the first set of slats.

2. The multi-partition blind system according to claim 1, further comprising a top partition rail having:
a first driver; and
a first shaft coupled to the first driver and coupled to the first slat control fixture, the first slat control fixture rotating the first set of slats in response to rotation of the first driver.

3. The multi-partition blind system according to claim 1, wherein the top partition rail further includes:
a second driver; and
a second shaft coupled to the second driver and coupled to the second slat control fixture, the second slat control fixture rotating the second set of slats in response to rotation of the second driver.

4. The multi-partition blind system according to claim 2, further comprising a midrail having:
a second driver; and
a second shaft coupled to the second driver and coupled to the second slat control fixture, the second slat control fixture rotating the second set of slats in response to rotation of the second driver.

5. The multi-partition blind system according to claim 4, wherein the midrail further comprises a first and a second fixture disposed on opposite ends of the midrail, the fixtures facilitating securing the midrail to sides of an architectural opening.

6. The multi-partition blind system according to claim 1, further comprising at least one set of lift cords coupled to at least one of the first and the second partition of blinds.

7. The multi-partition blind system according to claim 6, wherein the at least one set of lift cords are coupled to a spring force balance to facilitate lifting and lowering the first and the second partition of blinds.

8. The multi-partition blind system according to claim 7, wherein the at least one set of lift cords include a first, a second and a third lift cords, the first lift cords coupled to the first partition to facilitate lifting and lowering the first partition, the second lift cords coupled to the second partition to facilitate lifting and lowering the second partition, and the third lift cords coupled to a midrail of the second partition to facilitate lifting and lowering the midrail.

9. A multi-partition blind system comprising:
a top partition rail coupled to a first and a second side partition rail; and
a plurality of slats, each slat of the plurality of slats having a slat control fixture to facilitate independent rotation of each respective slat.

10. The multi-partition blind system according to claim 9, further comprising at least one processor, the at least one processor coupled to a first driver of each slat control fixture, each of the drivers controlling the rotational movement of the respective slat.

11. The multi-partition blind system according to claim 10, wherein each slat control fixture further comprises a clamp coupled to at least one second driver, the clamp having an open position in which the respective slat is rotationally decoupled from the slat control fixture and an closed position in which the respective slat is rotationally coupled to the slat control fixture.

12. The multi-partition blind system according to claim 11, further comprising a plurality of indicators, each indicator corresponding to a slat of the plurality of slats and indicative of a rotational engagement of the respective slat.

13. The multi-partition blind system according to claim 9, wherein the first side partition rail further comprises a ladder system that selectively receives an end of each slat of the plurality of slats, and wherein each slat further comprises a spring loaded movable pin that, in response to actuation, moves the end of the slat into and out of the ladder system.

14. The multi-partition blind system according to claim 13, wherein the second side partition rail further comprises a first guide track having at least one first wheel and a second guide track having a second wheel, the at least one first wheel actuating the spring loaded movable pin to facilitate moving the end of the slat into the ladder system and the second wheel actuating the spring loaded movable pin to facilitate moving the end of the slat out of the ladder system.

15. The multi-partition blind system according to claim 9, further comprising cords coupled to the plurality of slats, a spring force balance, and at least one of an automatic and a manual control device.

16. A multi-partition blind system comprising:
a top partition rail;
a first partition of vertical blinds comprising:
a first guide shaft;
a plurality of first fixtures coupled to the first guide shaft, each first fixture corresponding to a respective vertical blind of the first partition of vertical blinds; and
a first driver fixture coupled to the first guide shaft; and
a second partition of vertical blinds comprising:
a second guide shaft;
a plurality of second fixtures coupled to the second guide shaft, each second fixture corresponding to a respective vertical blind of the second partition of vertical blinds; and
a second driver fixture coupled to the second guide shaft.

17. The multi-partition blind system according to claim 16, wherein each first fixture rotationally couples the first guide shaft to the respective vertical blind of the first partition and wherein each second fixture rotationally couples the second guide shaft to the respective vertical blind of the second partition.

18. The multi-partition blind system according to claim 16, further comprising a plurality of tie links, a tie link of the plurality of tie links coupling adjacent fixtures of the plurality of first and second fixtures.

19. The multi-partition blind system according to claim 16, wherein the first driver fixture rotationally drives the first guide shaft and the second driver fixture rotationally drives the second guide shaft.

20. The multi-partition blind system according to claim 16, further comprising a partition appendage connector coupling a second fixture to an adjacent first fixture.
